(19) United States
(12) Patent Application Publication
(10) Pub. No.: US 2026/0131250 A1
(43) Pub. Date: May 14, 2026

(54) PROGRAM, INFORMATION PROCESSING SYSTEM, AND INFORMATION PROCESSING METHOD

(71) Applicant: CYGAMES, INC., Tokyo (JP)

(72) Inventors: Kazuhiro Harada, Tokyo (JP); Daisuke Kaneko, Tokyo (JP); Yohei Yamagishi, Tokyo (JP)

(73) Assignee: CYGAMES, INC., Tokyo (JP)

(21) Appl. No.: 19/032,314

(22) Filed: Jan. 20, 2025

Related U.S. Application Data
(63) Continuation of application No. PCT/JP2023/026083, filed on Jul. 14, 2023.

(30) Foreign Application Priority Data
Jul. 25, 2022 (JP) 2022-117741

(51) Int. Cl. A63F 13/69; A63F 13/533; A63F 13/79; A63F 13/825

(52) U.S. Cl. CPC A63F 13/69; A63F 13/533; A63F 13/79; A63F 13/825

(57) ABSTRACT

Provided are a program, an information processing system, and an information processing method for reducing a player's burden of repeatedly executing a game. Provided are a program, an information processing system, and an information processing method for a game in which a character having factor information tied thereto is registered in a database so as to be tied to a player, wherein, on the basis of a result of the character being nurtured, factor information tied to the nurtured character is decided, and the factor information tied to the character can be changed after the player has been notified of the factor information.

### CROSS-REFERENCE TO RELATED APPLICATIONS

This application is a continuation of International Patent Application No. PCT/JP2023/026083, having an international filing date of Jul. 14, 2023, which designated the United States, the entirety of which is incorporated herein by reference. Japanese Patent Application No. 2022-117741 filed on Jul. 25, 2022 is also incorporated herein by reference in its entirety.

### BACKGROUND OF THE INVENTION

The present invention relates to a program, an information processing system, and an information processing method for a game in which specific information is associated with a game medium.

There are well-known games that provide a nurturing function for nurturing a game medium such as a character (refer to Publication of Japanese Patent No. 7035123). For example, in Publication of Japanese U.S. Pat. No. 7,035,123, according to the result of nurturing a character, which is a game medium serving as a nurturing object, specific information is imparted to the character the nurturing of which is completed, so that the character can be used for the next round of character nurturing.

However, in games for providing such a nurturing function, players are given only a limited chance to earn specific information at the completion of nurturing and thus need to repeatedly execute games many times by using the nurturing function until they can earn desired specific information. This burden of repeatedly executing games may discourage players from executing games continually if they have difficulty taking enough time to execute games.

### SUMMARY OF THE INVENTION

The present invention has been conceived in light of the above-described circumstances, and an object thereof is to provide a program, an information processing system, and an information processing method for reducing a player's burden of repeatedly executing games.

According to a first aspect of the disclosure, there is provided a program for a game in which a game medium having specific information tied thereto is registered in a database so as to be tied to a player, the program causing a computer to function as:
a specific information decision unit for deciding specific information to be tied to the game medium used in a predetermined game on the basis of a result of the predetermined game being executed; and
a specific information change unit for making it possible to change the specific information to be tied to the game medium after the player has been notified of the specific information.

According to a second aspect of the disclosure, there is provided an information processing system for a game in which a game medium having specific information tied thereto is registered in a database so as to be tied to a player, the information processing system comprising:
a specific information decision unit for deciding specific information to be tied to the game medium used in a predetermined game on the basis of a result of the predetermined game being executed; and
a specific information change unit for making it possible to change the specific information to be tied to the game medium after the player has been notified of the specific information.

According to a third aspect of the disclosure, there is provided an information processing method for a game in which a game medium having specific information tied thereto is registered in a database so as to be tied to a player, the method comprising:
a specific information decision step for deciding specific information to be tied to the game medium used in a predetermined game on the basis of a result of the predetermined game being executed; and
a specific information change step for making it possible to change the specific information to be tied to the game medium after the player has been notified of the specific information.

### BRIEF DESCRIPTION OF DRAWINGS

FIG. 1 is a drawing showing the overall configuration of an information processing system.

FIG. 2 is a functional block diagram of a server, showing portions related to a nurturing function for nurturing a character among the functions realized in the information processing system.

FIG. 3 is a functional block diagram of a player terminal, showing portions related to the nurturing function for nurturing a character among the functions realized in the information processing system.

FIG. 4 is a flowchart showing an example of processing related to the nurturing function for nurturing a character.

FIG. 5 is a drawing showing an example of a nurturing-character selection screen displayed in the player terminal.

FIG. 6 is a drawing showing an example of an inheritance-character selection screen displayed in the player terminal.

FIG. 7 is a drawing showing an example of an inheritance-character list screen displayed in the player terminal.

FIG. 8 is a drawing showing an example of the inheritance-character selection screen displayed in the player terminal.

FIG. 9 is a drawing showing an example of the inheritance-character selection screen displayed in the player terminal.

FIG. 10 is a drawing showing an example of a support organization screen displayed in the player terminal.

FIG. 11 is a drawing showing an example of a final confirmation screen displayed in the player terminal.

FIG. 12 is a drawing showing an example of a nurturing home screen displayed in the player terminal.

FIG. 13 is a drawing showing an example of a training screen displayed in the player terminal.

FIG. 14 is a drawing showing an example of a race list screen displayed in the player terminal.

FIG. 15 is a drawing showing an example of the nurturing home screen displayed in the player terminal.

FIG. 16 is a drawing showing an example of the race list screen displayed in the player terminal.

FIG. 17 is a drawing showing an example of a goal-achievement notification screen displayed in the player terminal.

FIG. 18 is a drawing showing an example of a goal list screen displayed in the player terminal.

FIG. 19 is a drawing showing an example of a nurturing-goal completion screen displayed in the player terminal.

FIG. 20 is a drawing showing an example of the goal list screen displayed in the player terminal.

FIG. 21 is a flowchart showing an example of processing concerning decision of factor information.

FIG. 22 is a drawing showing an example of a final confirmation dialog displayed in the player terminal.

FIG. 23 is a drawing showing an example of an earned-factor notification screen displayed in the player terminal.

FIG. 24 is a drawing showing an example of a factor-determination confirmation dialog displayed in the player terminal.

FIG. 25 is a drawing showing an example of a factor re-earning confirmation dialog displayed in the player terminal.

FIG. 26 is a drawing showing an example of an earning-factor selection screen displayed in the player terminal.

FIG. 27 is a drawing showing an example of the earning-factor selection screen displayed in the player terminal.

FIG. 28 is a drawing showing an example of a factor list dialog displayed in the player terminal.

FIG. 29 is a drawing showing an example of the factor-determination confirmation dialog displayed in the player terminal.

### DETAILED DESCRIPTION OF THE INVENTION

(1) The present embodiment relates to a program for a game in which a game medium having specific information tied thereto is registered in a database so as to be tied to a player, the program causing a computer to function as: a specific information decision unit for deciding specific information to be tied to the game medium used in a predetermined game on the basis of a result of the predetermined game being executed; and a specific information change unit for making it possible to change the specific information to be tied to the game medium after the player has been notified of the specific information.

(2) In the program according to the present embodiment, the predetermined game may be a game for nurturing the game medium, and the specific information decision unit may decide the specific information to be tied to the game medium with reference to a status, at a predetermined point of time, of the game medium serving as a nurturing object in the predetermined game.

(3) In the program according to the present embodiment, the predetermined game may be a game for nurturing the game medium, and the program may cause the computer to function as a specific information application unit that, in the case where the game medium is nurtured in the predetermined game, affects a status of the game medium serving as a nurturing object according to specific information tied to a game medium nurtured in the past.

(4) In the program according to the present embodiment, the specific information change unit may accept a specific input for requesting to re-decide specific information after the player has been notified of the specific information, and the specific information decision unit, on the basis of the specific input being made, may re-decide the specific information to be tied to the game medium under the same condition as that for the specific information notified to the player.

(5) In the program according to the present embodiment, the specific information change unit may display specific information acquired earlier for the game medium and specific information acquired later for the game medium so that the two items of specific information can be compared and may allow the player to select which of the two items of specific information is to be tied to the game medium.

(6) The present embodiment relates to an information processing system for a game in which a game medium having specific information tied thereto is registered in a database so as to be tied to a player, the information processing system including: a specific information decision unit for deciding specific information to be tied to the game medium used in a predetermined game on the basis of a result of the predetermined game being executed; and a specific information change unit for making it possible to change the specific information to be tied to the game medium after the player has been notified of the specific information.

(7) The present embodiment relates to an information processing method for a game in which a game medium having specific information tied thereto is registered in a database so as to be tied to a player, the method including: a specific information decision step for deciding specific information to be tied to the game medium used in a predetermined game on the basis of a result of the predetermined game being executed; and a specific information change step for making it possible to change the specific information to be tied to the game medium after the player has been notified of the specific information.

The aforementioned program, information processing system, and information processing method according to the present embodiment make it possible to change specific information to be tied to a game medium used in a predetermined game on the basis of a result of the predetermined game being executed. This can reduce a player's burden of repeatedly executing the predetermined game until he/she can obtain desired specific information.

An embodiment of the present invention will be described below. Note that the embodiment described below does not unjustifiably limit the content of the invention as specified in the claims. Furthermore, not all the components described in the context of this embodiment are necessarily indispensable elements constituting the present invention.

### 1. Configuration of Information Processing System

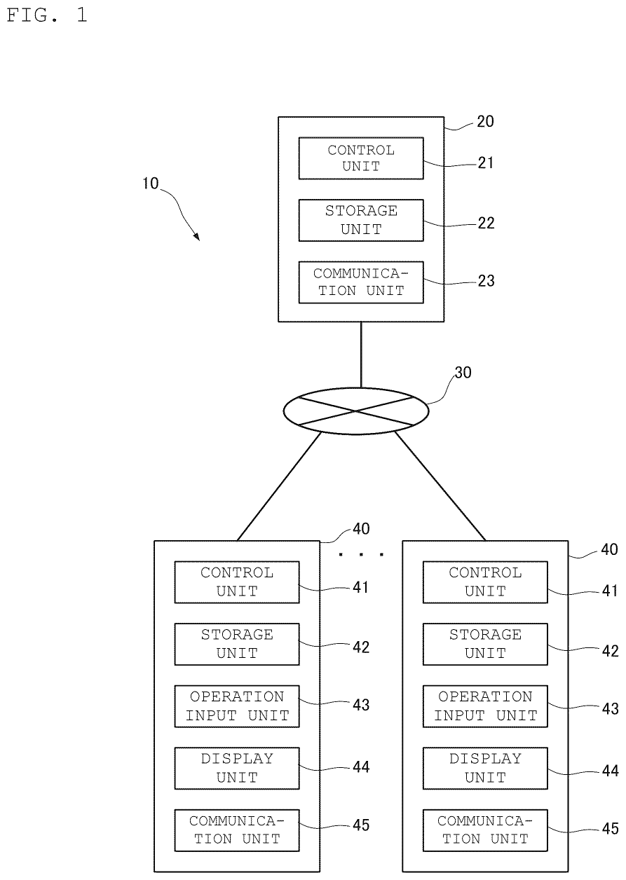

FIG. 1 is a drawing showing the overall configuration of an information processing system 10 according to this embodiment. As shown in FIG. 1, in the information processing system 10, a server 20 and a plurality of player terminals 40 are connected via a network 30, such as the Internet, a mobile phone network, a LAN, or a WAN, whereby what is called a client-server communication system is configured. Furthermore, each of the plurality of player terminals 40 carries out communication mutually with the server 20 via the network 30 to transmit and receive various kinds of information. In addition, each of the plurality of player terminals 40 carries out communication mutually with the other player terminals 40 via the network 30 and the server 20 to transmit and receive various kinds of information.

The server 20 includes: a control unit 21 constituted of a processor, such as a CPU; a storage unit 22 constituted of a main storage device, such as a ROM or a RAM, and an auxiliary storage device, such as an HDD or an SSD; and a communication unit 23 constituted of a communication module or a communication interface. In the server 20, the control unit 21 executes various kinds of processing according to programs stored in the storage unit 22. In addition, the server 20, by means of the communication unit 23, receives information from the player terminals 40 and transmits, to the player terminals 40, information, etc., concerning the results of processing executed by the control unit 21.

Each of the player terminals 40 is a smartphone, a tablet, a personal computer, a portable game machine, a stationary game machine installed in a store or a home, or the like. Each of the player terminals 40 includes: a control unit 41 constituted of a processor, such as a CPU; a storage unit 42 constituted of a main storage device, such as a ROM or a RAM, and an auxiliary storage device, such as a flash memory, an HDD, or an SDD; an operation input unit 43 constituted of a touchscreen, a keyboard, a microphone, etc.; a display unit 44 constituted of a liquid crystal display, an organic EL display, or the like; and a communication unit 45 constituted of a communication module or a communication interface. Each of the player terminals 40 also executes various kinds of processing according to programs stored in the storage unit 42. In addition, each of the player terminals 40, by means of the communication unit 45, receives information from the server 20 and transmits information to the server 20 and other player terminals 40.

The information processing system 10 according to this embodiment has a function for providing, through the player terminals 40, a game in which a character based on a racehorse motif is nurtured and the nurtured character is made to enter in a race to compete with other characters. In particular, the information processing system 10 according to this embodiment has a nurturing function for nurturing a character, a competition function for causing the nurtured character to compete with other characters in a race, etc. The following descriptions assume that the nurturing function and the competition function are realized mainly by a player terminal 40. It should be noted, however, that the aforementioned functions may be realized mainly by the server 20 or realized so as to be shared among the server 20 and the player terminal 40.

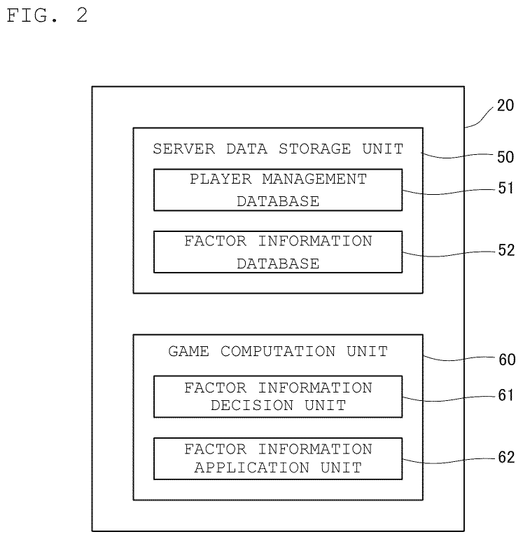

FIG. 2 is a functional block diagram showing main functions of the server 20.

The server 20 in the information processing system 10 has a function for managing players, characters, etc. on the basis of various kinds of identification information, as well as a function for executing computation needed to proceed with the game in response to requests from the player terminals 40 and transmitting results of the computation to the player terminals 40. These functions are realized by a server data storage unit 50 and a game computation unit 60 in a cooperative manner.

The server data storage unit 50 includes a player management database 51 and is realized mainly by the storage unit 22. In this embodiment, a character list, an item list, a nurturing object list, etc. are stored in the player management database 51 so as to be tied to a player ID imparted to each of the players.

The character list includes, for example: a character individual ID imparted to each nurtured character; a character type ID indicating the type of the character; statuses of the character (rarity, evaluation score, course aptitudes, distance aptitudes, running style aptitudes, way of running, speed, stamina, power, spirit, wisdom, possessed skills, earned title, and factor information); a lock state (locked and unlocked); and nurturing history of the character (nurturing conditions (information concerning selection of inheritance characters, information concerning organization of support items, etc.) and competition records in entry races during nurturing), etc.

In this embodiment, the phrase “nurtured character” refers to a character that has been nurtured by means of the nurturing function, which is one of the game functions realized in the information processing system 10 according to this embodiment, and that has statuses determined as a result of the nurturing being completed.

In addition, in this embodiment, the phrases “character individual ID” and “character type ID” are used, and they differ from each other as follows.

First, a “character individual ID” is an ID that is imparted to a character when nurturing of the character is completed in the nurturing function and the nurtured character is registered in the character list, and is used to identify each of the nurtured characters tied to the player ID.

Furthermore, this embodiment is designed so that the player selects a nurturing object from a plurality of kinds of characters in the nurturing function, and a “character type ID” is an ID imparted to identify the kind of a nurtured character.

In addition, the “lock state” imparted to a nurtured character indicates whether or not the transfer (deletion from the character list) of the nurtured character is prohibited, and the character can be transferred when unlocked and cannot be transferred when locked. Examples of the situation in which a nurtured character is locked are in the case where the nurtured character is individually specified by the player in the list of nurtured characters, in the case where the nurtured character is entry-registered in a race, and so on.

The nurturing object list stores data indicating which information of “released” and “un-released” is associated with each of the character type IDs. In this embodiment, a character with which the information of “released” is associated in the nurturing object list is a character that can be selected by the player as a nurturing object in the nurturing function. Furthermore, in this embodiment, a character can be newly released by means of a releasing item and a character earning lottery, and the number of characters that can be selected as nurturing objects differs depending on the player. In the following, a character that can be selected as a nurturing object in the nurturing function may be referred to as a “released character”.

The item list includes data concerning: items possessed by the player; strengthening points; trainer points (TP); and in-game currency. In this embodiment, for example, the content of possessed items, the number of possessed items, the amount of possessed strengthening points, the amount of possessed trainer points (TP), the amount of possessed in-game currency, etc. are stored in the player management database 51 as the item list.

An item in this embodiment is used to, for example, support character nurturing and change race entry conditions, and can be acquired according to race results, can be acquired by consuming in-game currency, etc.

Furthermore, strengthening points are used, for example, to strengthen a support item, which is an item for supporting character nurturing, and the more strengthened the support item, the more advantageous the nurturing environment in which the character can be nurtured.

In addition, trainer points (TP) are points used to nurture a character by using the nurturing function. In starting nurturing, it is possible to start character nurturing by consuming the trainer points (TP) corresponding to the consumption necessary for one round of nurturing. Moreover, in this embodiment, trainer points (TP) also need to be consumed when factor information to be tied to a character is re-earned after nurturing of the character has been ended.

Another item of data that is stored in the player management database 51 is a friend list. In this embodiment, the player can register other players as friends and thereby, in the nurturing function, can use a character and a support item rented from the other players registered as friends. Friend registration of another player is achieved by inputting the player ID of the player on a friend registration screen displayed on the display unit 44 of the player terminal 40 and then, in the case where the player corresponding to the player ID is available and can be registered as a friend, by making a tap input to a registration button provided on the friend registration screen. By doing so, the player ID of the other player to be registered as a friend is added to the friend list. There is an upper limit (e.g., 50) set on the number of friend registrations (the number of friend registrations) for each of the players, and there is also an upper limit (e.g., 100) set on the number of players by whom one player can be registered as a friend (the number of friend-registering players). For this reason, if neither the number of friend-registering players for another player the present player wishes to register as a friend nor the number of friend registrations for the present player reaches the respective upper limits, the present player can newly register the other player as a friend.

Also, the server data storage unit 50 includes a factor information database 52, which stores information, such as a factor name, a factor level, and a factor type, so as to tie the information to a factor registration ID. Factor information is information tied to a nurtured character in the case where the character is nurtured by means of the nurturing function. In this embodiment, on the basis of the factor information tied to the nurtured characters that have been selected as inheritance characters when a character is to be nurtured in the nurturing function, a factor inheritance event occurs as a game event for status reinforcement that affects abilities of the character serving as a nurturing object, such as an increase in skill acquisition levels and an increase in performance parameters.

Factor information includes four categories of factors: blue factor, red factor, unique factor, and white factor. Each item of factor information has three factor levels set therefor, and as the factor level of factor information is higher, the factor information can bring about an effect more advantageous in status reinforcement. Furthermore, the factor type is a detailed classification of the blue factor, red factor, unique factor, and white factor. The blue factor is factor information bearing the name of performance parameter and affects performance parameters. The higher the factor level, the larger the amount of increase in performance parameters. The red factor is factor information bearing the name of course aptitude, distance aptitude, or running style aptitude and affects the course aptitude, distance aptitude, or running style aptitude. The higher the factor level, the more easily the aptitude increases with a factor inheritance event. The unique factor is factor information bearing the name of unique skill and allows the acquisition of the unique skills of the inheritance characters. The higher the factor level, the more easily the acquisition level of the unique skill increases. The acquisition level of a skill affects the consumption of skill points when the skill is to be acquired, and the higher the acquisition level, the smaller the amount of consumption of skill points. The white factor is factor information belonging to none of the blue factor, red factor, and unique factor and includes a skill factor, a race factor, and a scenario factor. A skill factor is factor information bearing the name of skill, makes it easier to increase the acquisition level of normal skills (skills other than unique skills), and exists for each kind of skill. A race factor is factor information bearing the name of race, makes it easier to increase at least either a performance parameter or the acquisition level of a normal skill, and brings about effects that differ depending on the kind of race. A scenario factor is factor information bearing the name of nurturing scenario and is factor information concerning the nurturing scenario with which the character has been nurtured. In the case where a scenario factor is to be inherited by means of a factor inheritance event, it is possible to greatly increase a plurality of performance parameters, and which performance parameters are increased differ depending on the kind of the scenario factor. Furthermore, according to the aforementioned factor type, factor information is classified into six kinds: blue factor, red factor, unique factor, skill factor, race factor, and scenario factor.

The game computation unit 60 executes computation needed to proceed with the game in response to a request from the player terminal 40 and executes processing for transmitting the result of computation to the player terminal 40, transmitting, to the player terminal 40, data needed to proceed with the game in response to a request from the player terminal 40, etc. The game computation unit 60 is realized mainly by the control unit 41 and the communication unit 45. For example, upon receiving a request concerning training instructions from the player terminal 40 in the nurturing function, the game computation unit 60 executes computation for a result of training indicating whether the training has succeeded or failed, and transmits the result of computation to the player terminal 40. Furthermore, for example, upon receiving a request concerning a race entry in the nurturing function, the game computation unit 60 executes race competition simulation among a plurality of characters including the character serving as a nurturing object and non-player characters (NPC), and transmits the result of the competition simulation to the player terminal 40.

In addition, the game computation unit 60 includes a factor information decision unit 61. In the case where a character is nurtured in the nurturing function, the factor information decision unit 61 decides, by lottery, factor information to be tied to the nurtured character on the basis of the results of the nurturing.

The lottery for deciding factor information is drawn with reference to performance parameters, various kinds of aptitudes, and possessed skills of the character at the time the nurturing is ended, race entry history during nurturing, nurturing scenario, etc. For example, a blue factor is decided with reference to the performance parameters. In addition, for example, a red factor is decided with reference to various kinds of aptitudes. Furthermore, for example, a unique factor is decided with reference to the rarity of the character. Moreover, for example, skill factors are decided with reference to the possessed skills. In addition, for example, race factors are decided with reference to the race entry history during nurturing. Furthermore, for example, scenario factors are decided with reference to the nurturing scenario.

Thus, in this embodiment, with reference to the statuses, etc. of the character serving as a nurturing object in the nurturing function at the time the nurturing is ended, the factor information decision unit 61 decides factor information to be tied to the character the nurturing of which has been completed.

In a lottery for deciding factor information for a character the nurturing of which is completed, the factor information decision unit 61 executes a first process for deciding an earning object and a second process for deciding a factor level. In the first process concerning the blue factor, any one of speed, stamina, power, spirit, and wisdom is selected as an earning object. In the first process concerning the red factor, aptitudes with rank A or higher are extracted for the character the nurturing of which is completed, and any one of the extracted aptitudes is selected as an earning object. In the first process concerning the unique factor, on the basis of the rarity of the character the nurturing of which is completed, a unique skill is decided as an earning object if the rarity is a predetermined stage or higher. In the first process concerning the white factor, it is decided whether or not each of the white-factor candidates based on the possessed skills, race entry history, and selected scenario is won, so that the white factors that have been won are decided as earning objects. Also, regarding the items of factor information decided as earning objects in the first process, the factor information decision unit 61 decides, in the second process, a factor level of each of the items of factor information from level 1 to level 3. Note that, in this embodiment, the factor level is treated in the order of level 1<level 2<level 3, with level 3 being the highest and level 1 being the lowest.

In addition, upon request from the player terminal 40, the factor information decision unit 61 redraws a lottery for deciding factor information to be tied to the nurtured character. In this embodiment, although factor information is decided by lottery at the time character nurturing is ended in the nurturing function, the player can request to re-earn factor information at his/her discretion. In particular, in this embodiment, in the case where an input for requesting to re-earn factor information is made at the player terminal 40, the factor information decision unit 61, on the basis of the request for re-earning of factor information being received from the player terminal 40, redraws a lottery for deciding factor information to be tied to the character at the player terminal 40 under the same lottery conditions as those for the factor information reported to the player.

Furthermore, the game computation unit 60 includes a factor information application unit 62. In the course where a character is nurtured in the nurturing function, the factor information application unit 62 decides, by lottery, factor information that affects statuses of the character serving as a nurturing object, on the basis of the factor information tied to the inheritance characters.

Specifically, in a factor inheritance event that occurs in the course of proceeding with character nurturing in the nurturing function, the factor information application unit 62 draws a factor inheritance lottery based on the factor information of the inheritance characters. This embodiment is designed so that two inheritance characters are selected at the time a character is nurtured. More specifically, in the factor inheritance event, the factor information application unit 62 decides, by the factor inheritance lottery, whether or not to invoke each of the items of factor information tied to the inheritance characters and reinforces statuses of the character serving as a nurturing object on the basis of the invoked factor information. In this embodiment, in the case where it is decided that factor information is invoked, effects according to the kind of the factor information to be invoked are imparted to the character serving as a nurturing object. The effects include an increase in performance parameters, an increase in aptitude rank, enabled acquisition of a skill, etc.

Thus, in this embodiment, in the case where a character is nurtured in the nurturing function, the factor information application unit 62 can affect the statuses of the character serving as a nurturing object according to the factor information tied to a character that was nurtured in the past.

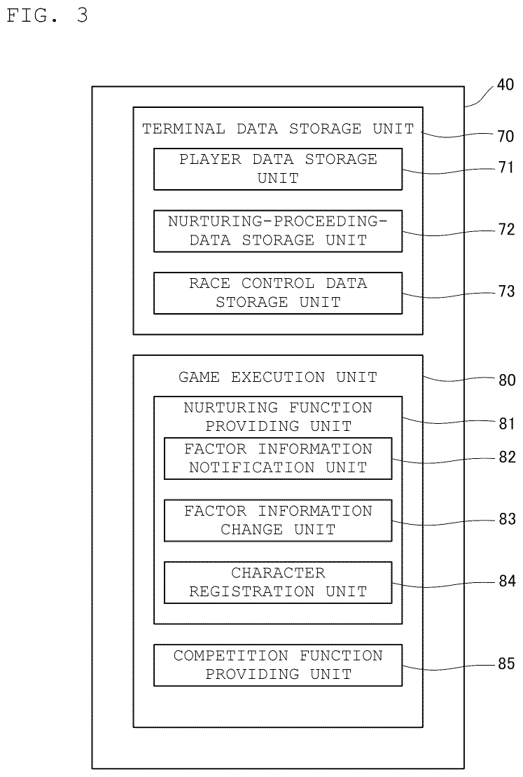

FIG. 3 is a functional block diagram showing main functions of the player terminal 40.

As shown in FIG. 3, the player terminal 40 in the information processing system 10 according to this embodiment realizes the nurturing function, the competition function, etc. through cooperative operation between a terminal data storage unit 70 and a game execution unit 80.

The terminal data storage unit 70 stores data required for the game execution unit 80 to execute various kinds of processing, and is realized mainly by the storage unit 42.

The terminal data storage unit 70 includes a player data storage unit 71, which stores, for example, data concerning the character list, nurturing object list, item list, and friend list corresponding to the player ID. In this embodiment, when the application is started and ended and in other situations as needed, the player data storage unit 71 of the player terminal 40 is synchronized with the player management database 51 of the server 20 with regard to data tied to the player ID (character list, nurturing object list, item list, friend list, etc.), so that various kinds of game processing are executed by using data stored in the player data storage unit 71. In this embodiment, in the case where the character list, the nurturing object list, the item list, or the friend list needs to be changed as a result of various kinds of game processing being executed, not only is the content stored in the player data storage unit 71 updated but also the stored content that has been updated is backed up in the player management database 51 of the server 20, whereby the content stored in the player data storage unit 71 is synchronized with the data stored in the player management database 51. Note that it is also acceptable to download, from the player management database 51 to the player data storage unit 71, the data tied to the player ID, such as the character list, the nurturing object list, the item list, and the friend list, as needed, such as when the application is started.

In addition, the terminal data storage unit 70 includes a nurturing-proceeding-data storage unit 72, which stores data needed to proceed with the nurturing function (nurturing-proceeding data) of a character that can be selected as a nurturing object in the nurturing function (character having a character type ID with which the information of “released” is associated in the nurturing object list). In this embodiment, nurturing goals, game events, etc. with regard to the nurturing function are prepared for each character, and nurturing-proceeding data, including at least details set as the nurturing goals and details set as the game events, is stored in the nurturing-proceeding-data storage unit 72 so as to be tied to the character type ID.

Also, the terminal data storage unit 70 includes a race control data storage unit 73, which stores: data that controls presentations, etc. of character motions and skill invocation when the player is allowed to watch a character entry race in the nurturing function and the competition function; and text data and audio data for live broadcasting of the race.

The game execution unit 80 executes: processing for starting a game in the case where a game start condition is satisfied; processing for executing a game mode selected from a plurality of kinds of game modes; processing for proceeding with the game; processing for causing an event to occur in the case where an event occurrence condition is satisfied; processing for computing game results; processing for ending the game in the case where a game ending condition is satisfied; processing for requesting the server 20 to execute computation; processing for acquiring results of computation and necessary data from the server 20; processing for transmitting results of computation and data in the player terminal 40 to the server 20; etc. The game execution unit 80 is realized mainly by the control unit 41 and the communication unit 45. In this embodiment, the game execution unit 80 includes a nurturing function providing unit 81 and a competition function providing unit 85.

The nurturing function providing unit 81 executes processing for providing the nurturing function for nurturing a character. In this embodiment, the nurturing function providing unit 81 accepts an input with regard to character nurturing, displays the result of computation in response to the input, etc.

In this embodiment, when a character is to be nurtured in the nurturing function, the player is required, in each turn, to select an action that is subjected to turn consumption. Actions that are subjected to turn consumption include training, entering in a race, going out, dispensary, etc. The nurturing function providing unit 81 accepts, through a nurturing home screen, etc. displayed on the display unit 44, the selection of an action that is subjected to turn consumption, and requests the server 20 to execute computation for a result of the selected action. Upon receiving the request, the server 20 executes computation for a result of the selected action and transmits the result of computation to the player terminal 40. The nurturing function providing unit 81 displays, on the display unit 44, a display screen corresponding to the result of computation received from the server 20.

In addition, in this embodiment, nurturing goals are set according to the type of the character serving as a nurturing object, and a predetermined turn may include a mandatory action that must be selected for a nurturing goal. Mandatory actions for a nurturing goal include, for example, entering in a predetermined race or winning a predetermined finish place in a predetermined race. In this case, in a turn in which a predetermined race associated with the nurturing goal is set, entering in the race is a mandatory action, thus prohibiting selection of a turn-consuming action other than entering in the race. Thus, in a turn in which selection of a mandatory action is accepted, the nurturing function providing unit 81 performs control for restricting the selection of an action different from the mandatory action.

Furthermore, the nurturing function providing unit 81 executes processing for acquiring, from the server 20, the factor information to be tied to the character the nurturing of which has been completed, notifying the player of the acquired factor information, and then, through approval given by the player, registering the character to which the factor information is tied in the character list in the player management database 51 and the character list in the player data storage unit 71. The nurturing function providing unit 81 includes a factor information notification unit 82, a factor information change unit 83, and a character registration unit 84.

The factor information notification unit 82 executes processing for acquiring, from the server 20, the factor information to be tied to the character the nurturing of which has been completed and notifying the player of the acquired factor information. Specifically, on the basis of character nurturing being ended in the nurturing function, the factor information notification unit 82 transmits a factor earning request to the server 20 and acquires, from the server 20, factor information scheduled to be tied to the character. Then, the factor information notification unit 82 notifies, through the display unit 44, the player of the factor information acquired from the server 20.

After the player has been notified of the factor information, the factor information change unit 83 executes processing for accepting an input for requesting to re-earn factor information and allowing changing of the factor information to be tied to the character the nurturing of which has been completed. Specifically, after the player has been notified of the factor information, the factor information change unit 83 accepts an input for determining the factor information or an input for re-earning factor information, transmits a factor re-earning request to the server 20 on the basis of the acceptance of an input for re-earning factor information, and acquires, from the server 20, the factor information decided by a redrawn lottery. In the case where factor information is re-earned, the factor information change unit 83 displays the factor information that has been earned earlier and the factor information that has been earned later with regard to the character the nurturing of which has been completed so that the two items of factor information can be compared, thereby allowing the player to select which of the two items of factor information should be tied to the character. Then, the factor information change unit 83 accepts selection as to which of the factor information that has been earned earlier and the factor information that has been earned later should be tied to the character and determines that the factor information corresponding to the result of selection is factor information to be tied to the character.

On the basis of the factor information to be tied to the character being determined, the character registration unit 84 registers the nurtured character in the character list in the player data storage unit 71 and transmits a character registration request to the server 20. Upon receiving the character registration request, the server 20 registers, in the character list in the player management database 51, the nurtured character corresponding to the character registration request.

The competition function providing unit 85 executes processing for providing the competition function in which a nurtured character possessed by the player is made to compete in a race with nurtured characters of other players and non-player characters (NPC).

In this embodiment, in the case where the player is a race organizer, the player can set the number of race entry registrations between 9 and 18 and entry-register a maximum of three nurtured characters in the race, with the remaining entry quota filled by nurtured characters of other players and non-player characters (NPC), thus allowing a race competition among the characters entry-registered in the race. Furthermore, in the case where the number of entry registrations in a race organized by another player does not reach the allowed upper limit, the player can entry-register a maximum of three nurtured characters in the race, thus allowing a race competition among the characters entry-registered in the race in the same manner as in the case where the player himself/herself is the organizer.

In the case where the race organizer allows a race entry at the player terminal 40, race competition simulation is executed at the server 20, and the competition function providing unit 85 allows the player terminal 40 to request the result of competition simulation from the server 20. In the player terminal 40 that has received the result of competition simulation from the server 20, the competition function providing unit 85 generates a race video based on the result of competition simulation on the basis of various kinds of data stored in the race control data storage unit 73 and displays the generated race video on the display unit 44, thus allowing the player to watch how the race proceeds.

### 2. Control Method in this Embodiment

In the following, a control method in this embodiment will be described by way of an example where the game program according to this embodiment is applied to a game application in the player terminal 40 provided in the form of a smartphone.

The game program according to this embodiment is configured so as to be capable of providing a plurality of kinds of game functions. In the nurturing function, which is a main game function, a character serving as a nurturing object is selected from a plurality of kinds of characters, statuses of the character change according to the proceeding of the game, and the statuses of the character are determined when a predetermined ending condition is satisfied, whereby the character nurturing is ended. A nurtured character has factor information according to the result of nurturing tied thereto, so that when the nurtured character is used as an inheritance character to nurture a new character, statuses of the character to be newly nurtured can be reinforced on the basis of the factor information tied to the inheritance character. In addition, in this embodiment, a quota for nurtured characters that can be possessed (number of characters that can be registered in the character list) is defined in advance, so that when the quota for possessed characters (e.g., 240) is filled, no new characters can be nurtured in the nurturing function. Because of this, it is necessary to delete a nurtured character from the character list to secure room in the quota for possessed characters. In the following, the outline of the nurturing function for nurturing a character will be described.

In the nurturing function, the player nurtures a character by selecting one character serving as a nurturing object from a plurality of kinds of characters at his/her discretion. Each of the plurality of kinds of characters that can be selected as nurturing objects has initial statuses set therein. In addition, each of the characters serving as nurturing objects acquires a unique skill (unique skill) according to the kind of the character from the start of nurturing. The conditions for invoking unique skills and the effects at the time those unique skills are invoked differ from one another. Furthermore, a plurality of kinds of characters that can be selected as nurturing objects have set therein growth correction rates of parameters, such as speed, stamina, power, spirit, and wisdom, according to the character, so that parameters that are readily increased are set for each of the kinds of characters.

When character nurturing is started after a nurturing object has been selected, the player can nurture a character by instructing nurturing in each of a maximum of 75 turns. Specifically, when the player instructs training associated with performance parameters, such as speed, stamina, power, spirit, and wisdom, performance parameters change and skill points are earned according to the result of training. Also, one turn can be consumed by instructing an entry in a race, so that performance parameters can change and skill points can be earned according to the result of the race. In addition, when an event occurrence condition is satisfied during nurturing, an event occurs, resulting in an increase in the number of kinds of acquirable skills and a change in performance parameters. Skill points as described above are points used to allow the character serving as a nurturing object to acquire a skill, so that the player can allow the character to acquire a skill from the list of acquirable skills by consuming possessed skill points.

Furthermore, in character nurturing, a plurality of nurturing goals are set for each character according to the kind of the character serving as a nurturing object. Examples of nurturing goals include entering in a target race, winning a predetermined or higher finish place in a target race, and earning a predetermined number of fans before a predetermined turn. In this embodiment, when the character being nurtured is made to enter in a race, the character can earn the number of fans according to the finish place, and race entry conditions based on the number of fans are specified according to the race.

Also, in this embodiment, a plurality of nurturing goals are set for each character in the turns up to the 72nd turn, whereas the 73rd to 75th turns constitute ending races. The ending races are held over the three turns constituting an elimination race, a semi-final race, and a final race, respectively. The player can give instructions as to nurturing before making the character enter in each of the three races.

Moreover, in this embodiment, in the case where a nurturing goal set in character nurturing is to win a finish place within a predetermined finish place in a target race, a continue function is available as a rescue function that is carried out when the character fails in winning a finish place within the specified finish place. This continue function is to give the player a chance to retry the target race, allowing the player to retry the target race by consuming the number of continue tokens that have been granted in advance. In this embodiment, the number of continue tokens is set to 3 through nurturing of one character.

Also, in a nurturing game function, the player can transition to a nurturing ending confirmation state as a result of any of the plurality of kinds of ending conditions defined in advance being satisfied.

First, in the case where the player reaches the final race, i.e., the 75th turn, of the ending races, the nurturing is ended as the final race ends. Note that in the case where the finish place is the second place or lower in the final race, the player can retry the final race as long as there is a remaining continue token. On the other hand, the nurturing is ended in the case where the finish place is the second place or lower in the final race after all continue tokens have been consumed. Note that it is up to the player whether or not to use the continue function, and in the case where the player selects not to use the continue function, the nurturing is ended at the time the selection is made.

The nurturing is also ended in the case where the player fails to achieve any of the nurturing goals set for each character in the turns up to the 72nd turn.

For example, in the case where a nurturing goal is to earn a predetermined number of fans, the nurturing is ended when the specified number of fans is not reached in a turn set in the nurturing goal. In this case, the player cannot use the continue function, and therefore, the nurturing is ended at the time the player reaches a turn subjected to a determination as to the nurturing goal because the predetermined number of fans are not reached.

In addition, for example, in the case where a nurturing goal is to enter in a target race, the nurturing goal is achieved as long as the character can enter in the target race, regardless of the finish place in the race. However, each race requires the player to have a predetermined number of fans, constituting a race entry condition, and in the case where the player fails to have the number of fans, constituting a race entry condition, in the turn corresponding to the target race, the nurturing is ended because the character cannot enter in the target race.

Furthermore, for example, in the case where a nurturing goal is to win a finish place within a predetermined finish place in a target race, the nurturing is ended when the race entry condition for the target race is not satisfied. Even though the character enters in the target race, the nurturing is also ended in the case where the character fails to win a place within the predetermined finish place and there is not a remaining continue token. As described above, it is up to the player whether or not to select the use of the continue function. In the case where the player selects not to use the continue function despite a remaining continue token, the nurturing is ended as a result of the nurturing goal not being achieved.

Furthermore, in the case where the player is in the 73rd turn or after, the player can proceed to the subsequent turn by wining the first place in each of the elimination race and the semi-final race of the ending races, and the nurturing is ended in the case where the player's finish place is the second place or lower and there are no remaining continue tokens. Also in this case, if the player selects not to use the continue function, the nurturing is ended at that time.

In this embodiment, the player transitions to the nurturing ending confirmation state when a nurturing ending condition is satisfied. This nurturing ending confirmation state gives the player the last chance to acquire a skill before the statuses are determined, so that the player can acquire a skill by consuming skill points possessed at that time. Furthermore, an input interface for allowing the player to make an input for confirming that the nurturing is ended is prepared in the nurturing ending confirmation state, and factor information is decided when the player makes an input for confirming that the nurturing is ended. In this embodiment, when the player is notified of the decided factor information, the player can request to re-earn factor information at his/her discretion, so that the player can select which of the factor information that has been earned earlier and the re-earned factor information should be tied to the current nurtured character. When factor information to be tied to the character the nurturing of which has been completed is determined, the statuses of the character serving as a nurturing object are determined, and information concerning that character is registered as a nurtured character in the character list in the player data storage unit 71 and the character list in the player management database 51.

When the statuses of the character serving as a nurturing object are determined via the nurturing ending confirmation state, rewards according to the result of nurturing are provided. In this embodiment, in-game currency, strengthening points, etc. according to the total numbers of fans earned until the end of nurturing are provided as rewards.

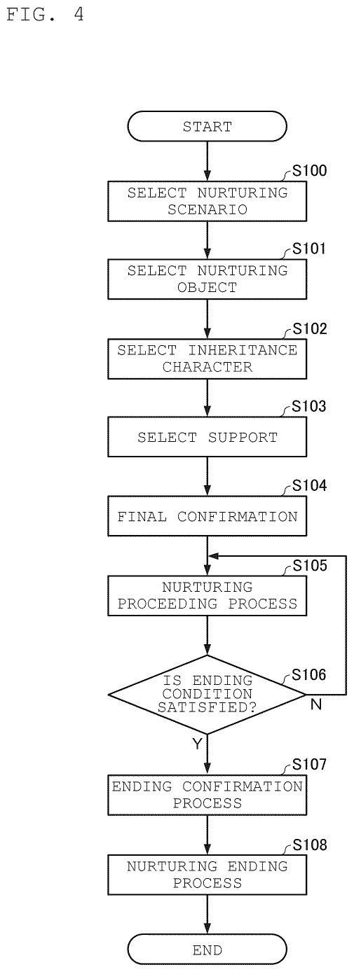

In the following, game proceeding in the nurturing function for nurturing a character will be described in more detail with reference to FIG. 4.

Selection of a nurturing scenario is accepted before character nurturing is started (step S100). In this embodiment, a plurality of kinds of nurturing scenarios are prepared, and how performance parameters are increased and how skills are acquired differ depending on the selected nurturing scenario. A nurturing scenario to be selected can be switched via a swipe input, and when an input for deciding a nurturing scenario (e.g., tap input to a decision button) is performed, selection of a character serving as a nurturing object is accepted with the selected nurturing scenario (step S101).

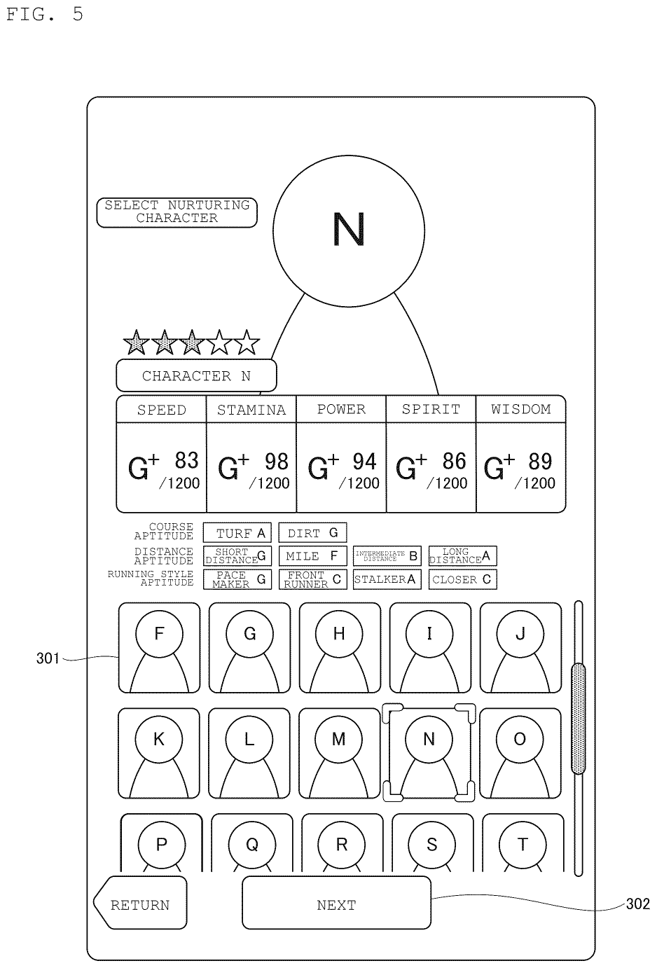

In this embodiment, as shown in FIG. 5, a nurturing object can be selected by tapping a character icon 301 for identifying a character on a nurturing-character selection screen. Information concerning characters selectable as nurturing objects (nurturable characters) is managed in the nurturing object list in the player data storage unit 71, and the nurturing-character selection screen is displayed by acquiring the character type IDs of the nurturable characters from the nurturing object list. On the nurturing-character selection screen, the player can confirm information concerning the initial statuses of the character being selected. In this embodiment, initial statuses the player can confirm on the nurturing-character selection screen include information concerning: performance parameters (speed, stamina, power, spirit, and wisdom); course aptitudes (turf track and dirt track); distance aptitudes (short distance, mile, intermediate-distance, and long distance); and running style aptitudes (pace maker, front runner, stalker, and closer).

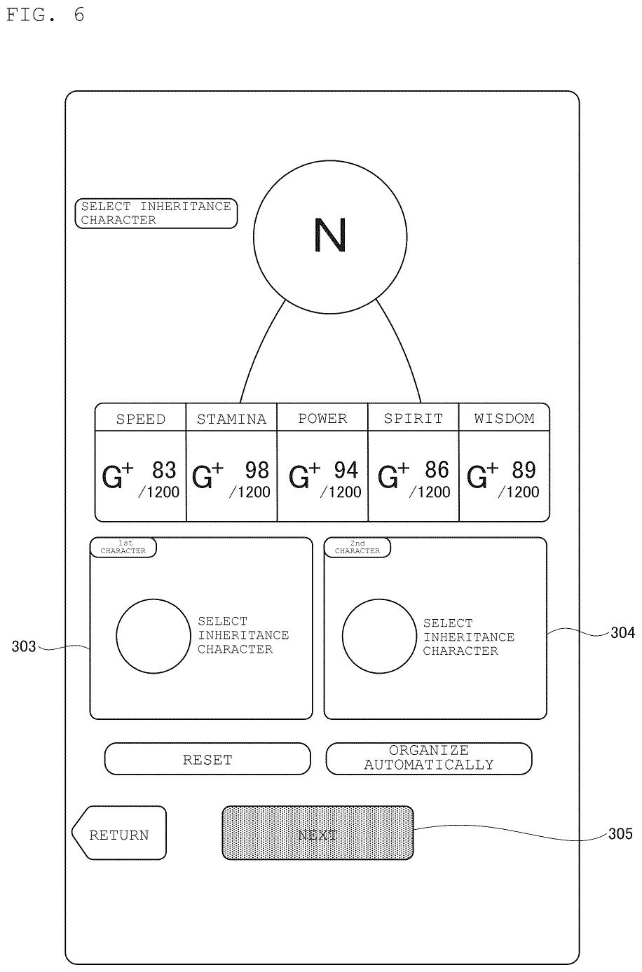

When a tap input is made to a proceeding button 302 on the nurturing-character selection screen shown in FIG. 5 while the character icon 301 of a character serving as a nurturing object is selected, the display screen transitions to an inheritance-character selection screen, as shown in FIG. 6, thereby accepting the selection of an inheritance character (step S102).

This embodiment is designed so that the player can select, as inheritance characters for new nurturing, two nurtured characters that were nurtured in the past and reinforce statuses of the character to be nurtured on the basis of the factor information tied to the two selected inheritance characters (information earned by the inheritance characters when they were nurtured).

In this embodiment, statuses of the character serving as a nurturing object are reinforced on the basis of factor information in a factor inheritance event that occurs when nurturing is started and when predetermined turns are reached after nurturing has been started. In the case where a factor inheritance event occurs during character nurturing in the nurturing function, an event result request is transmitted from the player terminal 40 to the server 20. In the server 20 that has received the event result request, a factor inheritance lottery is drawn on the basis of the factor information tied to the two inheritance characters, and a lottery result is transmitted to the player terminal 40. In the player terminal 40 that has received the lottery result, statuses of the character serving as a nurturing object are reinforced, such as an increase in performance parameters and an increase in the skill acquisition level, on the basis of the lottery result, and a display process for notifying the player of results of statuses being reinforced by means of the factor inheritance event is executed.

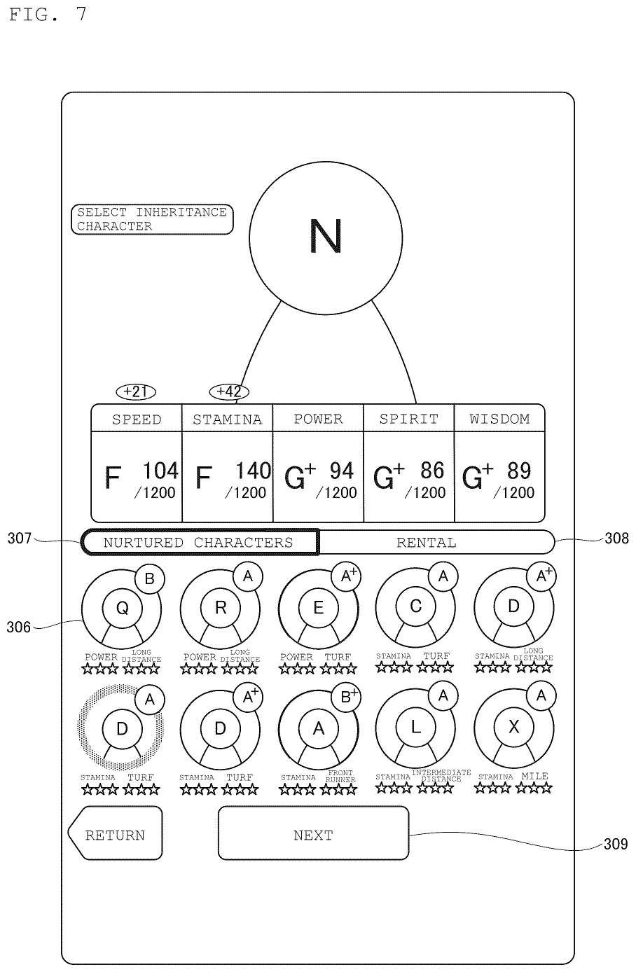

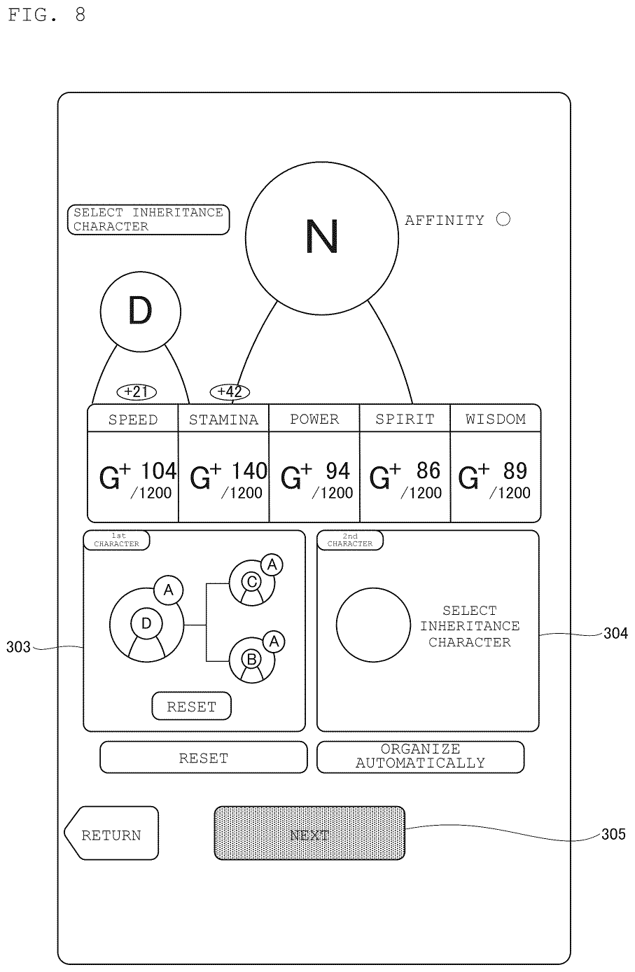

When selecting inheritance characters, the player makes a tap input to one of an inheritance frame 303 and an inheritance frame 304 for two characters, thereby displaying a list of selectable inheritance characters. When a tap input is made to the inheritance frame 303 (or the inheritance frame 304) on the inheritance-character selection screen shown in FIG. 6, an inheritance-character list screen is generated and displayed with reference to the character list in the player data storage unit 71 and the list of nurtured characters (inheritance character list), as shown in FIG. 7. On the inheritance-character list screen, a character can be selected by making a tap input to a character icon 306, and when a tap input is made to a proceeding button 309 while any of the inheritance characters is selected, the display screen returns to the inheritance-character selection screen, as shown in FIG. 8.

In addition, when selecting an inheritance character, the player can not only select a nurtured character nurtured by the player himself/herself but also rent and use a nurtured character nurtured by another character registered by the player as a friend. In this embodiment, a nurtured character nurtured by another character can be rented up to three times per day. On the inheritance-character list screen shown in FIG. 7, a nurtured character tab 307 and a rental tab 308 are provided, and when a tap input is made to the rental tab 308, a rental character acquisition request is transmitted to the server 20. Upon receiving the rental character acquisition request, the server 20 refers to friend registration information (profile information of other players registered as friends) tied to the player ID that has transmitted the rental character acquisition request and transmits, to the player terminal 40, the list of rental characters (rental character list) set in the profile information by the other players registered as friends. Also, at the player terminal 40, an inheritance-character list screen is generated and displayed on the basis of the received rental character list.

In addition, it is necessary to select two inheritance characters in order to start character nurturing, and a proceeding button 305 appears grayed out in a state in which only one inheritance character is selected, as shown in FIG. 8, thereby prohibiting proceeding with preparations for starting character nurturing.

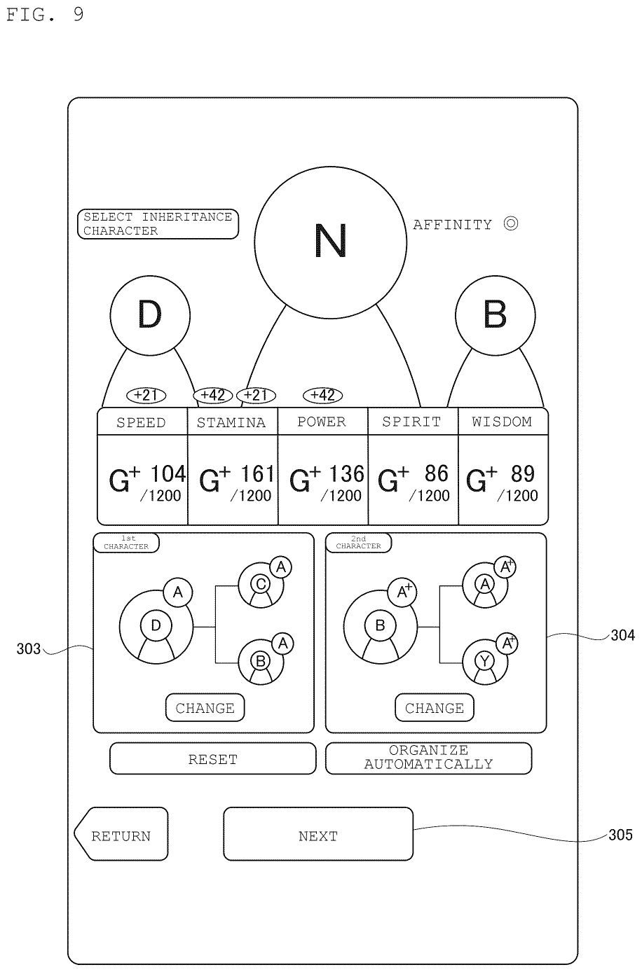

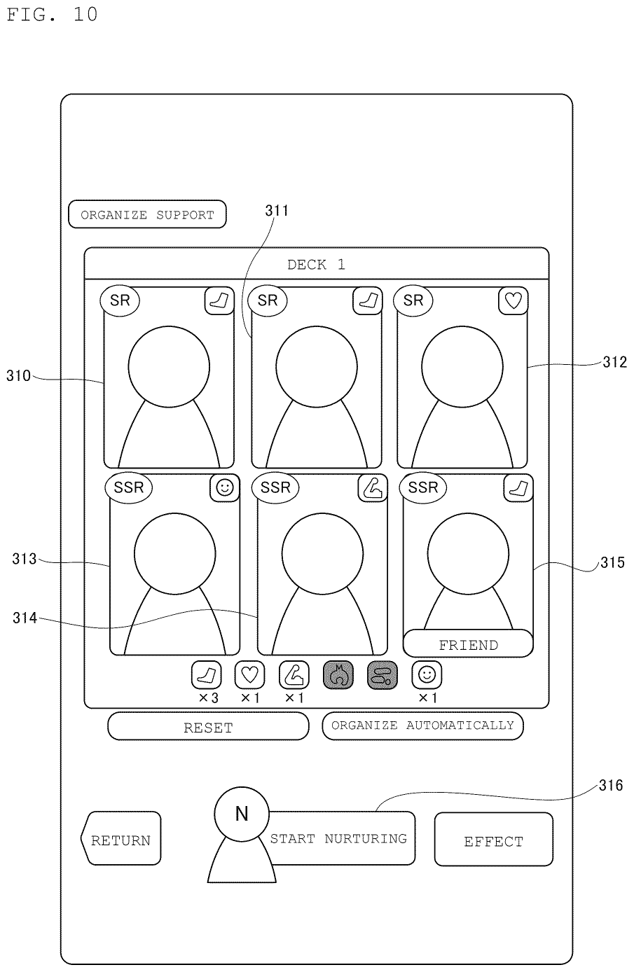

As shown in FIG. 9, when a tap input is made to the proceeding button 305 on the inheritance-character selection screen while two inheritance characters are selected, the display screen transitions to a support organization screen, as shown in FIG. 10, thus accepting selection of a support item (step S103).

In this embodiment, a support item simulating a card is available as an item for supporting character nurturing, and a support item allows the player to bring about the effect of increasing performance parameters and increase the number of kinds of acquirable skills. When a character is to be nurtured, it is necessary to organize six support items. Note that five of the six support items are selected from the support items possessed by the player himself/herself, and the remaining one support item, serving as a friend frame, is rented from support items possessed by other players.

Support items are classified, according to the performance thereof, into six categories: speed, stamina, power, spirit, wisdom, and friend. The support items of speed, stamina, power, spirit, and wisdom literally bring about the effect of increasing parameters corresponding to the performance parameters of the character at the time of training, and the support item of friend brings about the effect of recovering the physical strength and motivation. The category of a support item is identifiable by a category icon, and the player selects six support items used for this round of nurturing by drawing on the category icon. In addition, a support item has three stages of rarities: rare (R), super rare (SR), and special super rare (SSR). In this embodiment, the rarity becomes higher in the order of R<SR<SSR, and basically, the higher the rarity, the more profound the support effect.

As shown in FIG. 10, player support frames 310 to 314 for five support items and a friend support frame 315 for one support item are provided on the support organization screen. When a tap input is made to any of the player support frames 310 to 314, a list of support items (player support list) is acquired with reference to the item list in the player data storage unit 71. Also, a screen for displaying the list of support items possessed by the player is generated on the basis of the acquired player support list, thereby accepting selection of a support item. In addition, when a tap input is made to the friend support frame 315, a friend support acquisition request is transmitted to the server 20. Upon receiving the friend support acquisition request, the server 20 refers to the friend registration information tied to the player ID that has transmitted the friend support acquisition request and transmits, to the player terminal 40, a list of support items (friend support list) set in the profile information by other players registered as friends. In the player terminal 40, a screen for displaying a list of support items that can be set in the friend support frame 315 is generated on the basis of the received friend support list, thereby accepting selection of a support item.

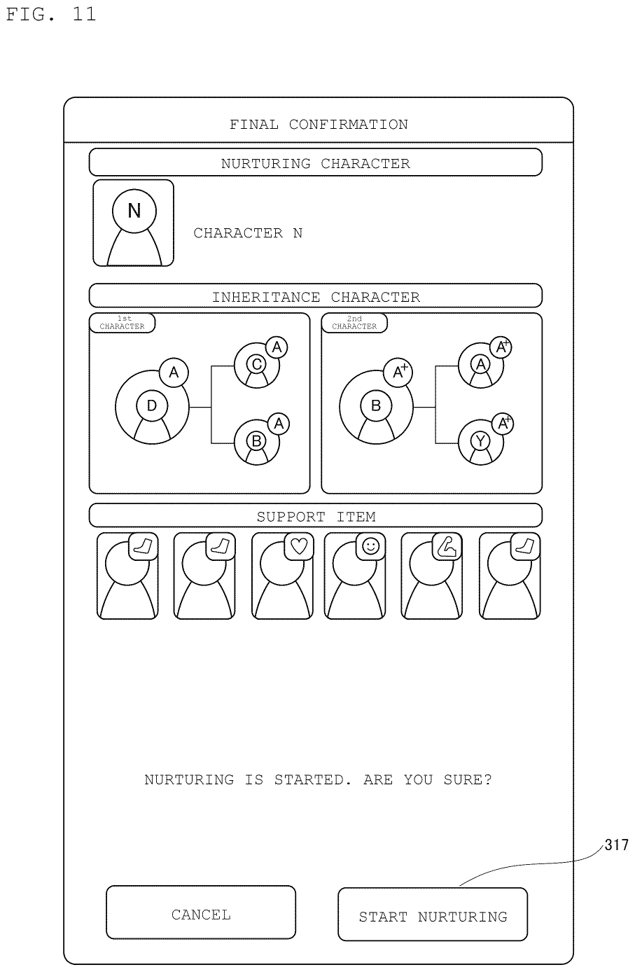

As shown in FIG. 10, when a tap input is made to a nurturing start button 316 while six support items are organized on the support organization screen, the display screen transitions to a final confirmation screen, as shown in FIG. 11, thus accepting the player's input for confirming start of nurturing (step S104). On the final confirmation screen, the character serving as a nurturing object, the inheritance characters, and the organized support items that have been selected by the player are displayed.

Also, when a tap input is made to a nurturing start button 317 on the final confirmation screen, a nurturing proceeding process for nurturing the character is executed (step S105). Note that, in this embodiment, when a tap input is made to the nurturing start button 317 on the final confirmation screen in a preparatory stage at the time nurturing is started, the character serving as a nurturing object is set as a default character. Through this setting of a default character, the default character can be set as an initially selected character on the nurturing-character selection screen when the next round of nurturing is to be executed. This is convenient to a player who repeatedly nurtures the same character. In addition, in this embodiment, it is necessary to consume trainer points (TP) possessed by the player in order to nurture a character in the nurturing function. Trainer points are recovered over time by a predetermined amount at a time, and can also be recovered by using a recovery item.

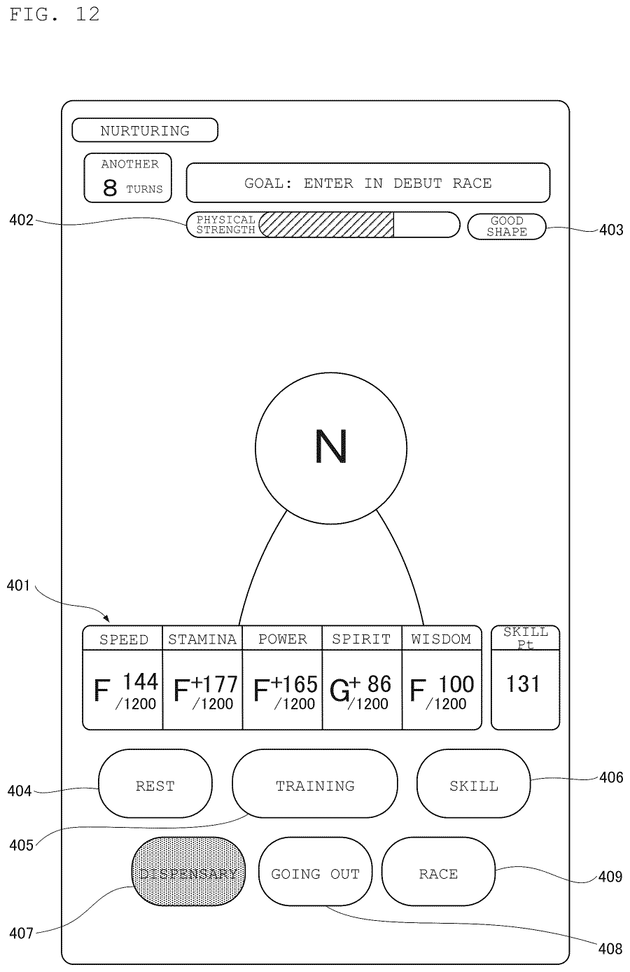

FIG. 12 shows an example of the nurturing home screen, which is a kind of display screen during character nurturing.

In the character nurturing function according to this embodiment, the display screen transitions basically from the nurturing home screen to a screen for instructing various kinds of actions, such as training. On the nurturing home screen, not only is the character serving as a nurturing object displayed in the form of animation but also a status indication field 401 is provided to display the current statuses of the character (speed, stamina, power, spirit, wisdom, and skill points).

Also, on the nurturing home screen, a physical strength gauge 402 and a motivation icon 403 are displayed. The physical strength gauge 402 is a gauge indicating the physical strength, which is a parameter that affects the failure rate of training, and varies with training or a race entry during nurturing, a game event that occurs during nurturing, etc. As the physical strength decreases, training is more likely to fail and the motivation decreases. In addition, the motivation icon 403 represents motivation, which is a parameter indicating physical condition of the character being nurtured, and, in this embodiment, is set to any of the five stages: very bad shape; bad shape; normal; good shape; and great shape. This parameter referred to as motivation affects training effects and performance parameters of the character when entering in a race. Training effects and performance parameters of the character when entering in a race are corrected to decrease in the case of “very bad shape” and “bad shape” than in the case of “normal”, and are corrected to increase in the case of “good shape” and “great shape” than in the case of “normal”.

Furthermore, on the nurturing home screen, buttons for selecting various kinds of actions, such as training, are provided, including a rest button 404, a training button 405, a skill button 406, a dispensary button 407, a going-out button 408, and a race button 409. In this embodiment, the player in principle is allowed to give instructions as to one kind of action (more specifically, any one kind of the rest, training, dispensary, going out, and race) in each turn, and when processing of the action corresponding to the instructions given in the current turn is completed, the current turn is consumed, advancing the game to the subsequent turn. Note that, in this embodiment, acquisition of a skill is an exception and does not involve consumption of a turn. In this embodiment, as described above, five kinds of actions including rest, training, dispensary, going out, and race are set as an action that consumes one turn in the nurturing function, and these actions may be referred to as turn consumption actions, as needed.

The rest button 404 is a button used to instruct the execution of rest for recovering the physical strength, and when a tap input is made to the rest button 404, a rest confirmation dialog box for confirming that the execution of rest is instructed is displayed. Subsequently, when a tap input is made to a decision button in the rest confirmation dialog box, a rest result request is transmitted to the server 20. In the server 20 that has received the rest result request, computation concerning the amount of recovery in the physical strength and whether or not to cause a game event to occur is executed, and a rest result response including the result of computation is transmitted to the player terminal 40. In the player terminal 40 that has received the rest result response, an animation for recovering the physical strength gauge 402 is displayed on the basis of the result of computation included in the rest result response, and in the case where a game event occurs, processing concerning the game event is executed.

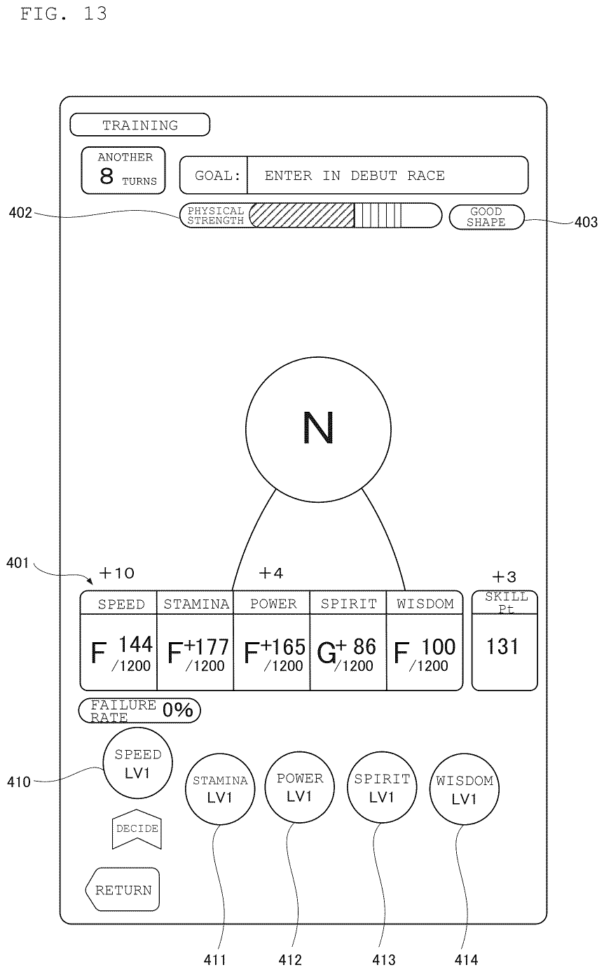

The training button 405 is a button used to instruct training for varying performance parameters of the character, and when a tap input is made to the training button 405, the display screen transitions to a training screen, as shown in FIG. 13.

On the training screen, a speed button 410, a stamina button 411, a power button 412, a spirit button 413, and a wisdom button 414 are placed in the region in which various kinds of buttons are placed on the nurturing home screen. In this embodiment, buttons used to instruct the respective training courses may be collectively referred to as training buttons for the sake of convenience of explanation.

On the training screen, training is instructed by making a tap input to the training button being selected, and the training button being selected can be switched by making a tap input to a training button different from the training button being selected.

On the training screen, when training is instructed with the training button being selected, which of the performance parameters are increased, about how much those performance parameters are increased, and about how much skill points can be earned are displayed. In the example shown in FIG. 13, the speed button 410 is selected, indicating that the speed increases by 10, the power increases by 4, and three skill points are earned in the case where speed training is instructed. In this embodiment, speed and power increase in the case where speed training is executed; stamina and spirit increase in the case where stamina training is executed; power and stamina increase in the case where power training is executed; spirit, power, and speed increase in the case where spirit training is executed; and wisdom and speed increase in the case where wisdom training is executed. Skill points can also be earned in the case where any kind of training is executed.

In this embodiment, support items organized before the start of nurturing are randomly associated with training in each turn by lottery drawn by the server 20, so that in a training course associated with a support item, performance parameters are increased more greatly and a larger amount of skill points are earned due to the effect of the support item when training is executed.

In the case where training is executed, the physical strength is consumed. Consumption of the physical strength due to training can be confirmed in advance with the physical strength gauge 402 on the training screen. The physical strength is a parameter affecting the failure rate in training, and the failure rate is likely to increase as the physical strength decreases. In this embodiment, in the case where training is instructed, the server 20 decides whether or not training has failed by drawing a lottery based on the failure rate. In the case where the training does not fail (training succeeds), the performance parameters corresponding to the training instructions are increased, and in the case where the training fails, the performance parameters do not increase and the physical strength is consumed.

When a tap input is made to the training button being selected on the training screen, a training result request is transmitted to the server 20. In the server 20 that has received the training result request, computation as to a result of the training and whether or not to cause a game event to occur is executed, and a training result response including the result of computation is transmitted to the player terminal 40. In the player terminal 40 that has received the training result response, a display process concerning the result of training (display concerning whether training has succeeded or failed and display for varying performance parameters) is executed on the basis of the result of computation included in the training result response, and in the case where a game event occurs, processing concerning the game event is executed.

The skill button 406 is a button for allowing the character to acquire a skill, and when a tap input is made to the skill button 406, a skill acquisition screen indicating a list of skills that can be acquired by the character at that time is displayed. When a tap input is made to an acquisition button with a skill being selected on the skill acquisition screen, a skill acquisition request is transmitted to the server 20. In the server 20 that has received the skill acquisition request, the skill specified with the skill acquisition request is registered as an acquired skill in status information of the character being nurtured, and a skill acquisition completion response is transmitted to the player terminal 40. In the player terminal 40 that has received the skill acquisition completion response, processing for displaying that skill acquisition has been completed and displaying the skill acquired on the skill acquisition screen as an acquired skill is executed.

The dispensary button 407 is a button used to eliminate a bad status imparted to the character being nurtured, and an input is accepted only in the case where a bad status is imparted due to a game event during nurturing. In this embodiment, a bad status, such as lack of sleep, may be imparted as a result of a game event occurring. When a bad status is imparted, a game event disadvantageous for nurturing, such as the physical strength being more likely to decrease and the motivation being more likely to decrease, is more likely to occur. The dispensary button 407 appears grayed out in the case where no bad statuses are imparted to the character being nurtured. On the other hand, the dispensary button 407 is displayed normally and accepts a tap input in the case where a bad status is imparted to the character being nurtured. In the case where the elimination of a bad status is instructed by using the dispensary button 407, a dispensary result request is transmitted to the server 20. In the server 20 that has received the dispensary result request, a lottery is drawn to decide whether or not the bad status has been eliminated, and a dispensary result response including a result of the decision is transmitted to the player terminal 40. In the player terminal 40 that has received the dispensary result response, in the case where the bad status is eliminated, processing for informing the player that the bad status has been eliminated and eliminating the bad status from the status indication of the character is executed.

The going-out button 408 is a button used to increase the motivation of the character being nurtured. When a tap input is made to the going-out button 408, a going-out confirmation dialog box for confirming that going out is instructed is displayed. Subsequently, when a tap input is made to the decision button in the going-out confirmation dialog box, a going-out result request is transmitted to the server 20. In the server 20 that has received the going-out result request, a lottery concerning a motivation increase event is drawn, a going-out result response including information concerning the motivation increase event decided by the lottery is transmitted to the player terminal 40. In the player terminal 40 that has received the going-out result response, processing concerning the motivation increase event is executed on the basis of the information included in the going-out result response.

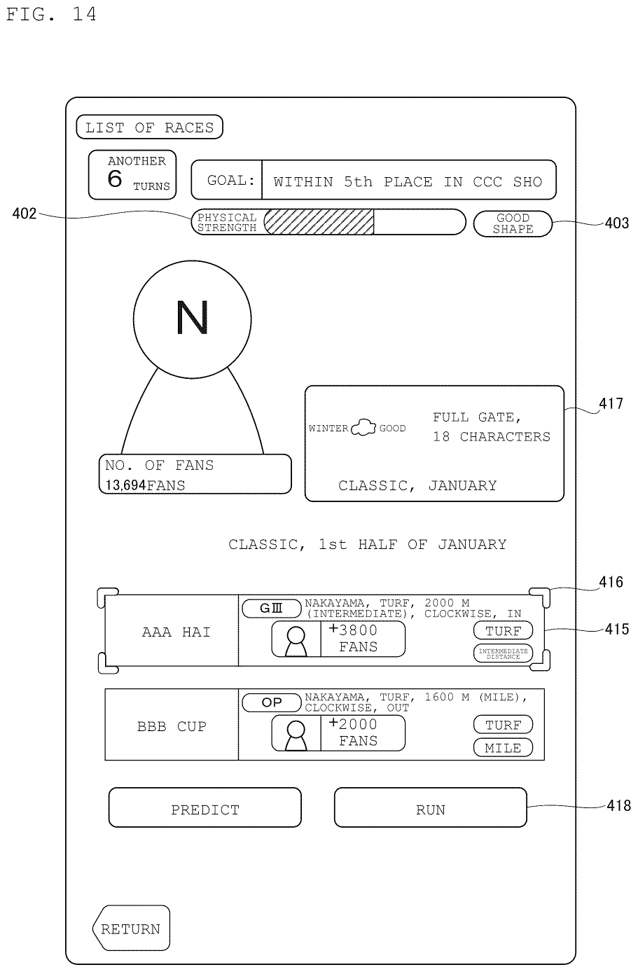

The race button 409 is a button used to cause the character being nurtured to enter in a race. When a tap input is made to the race button 409, the display screen transitions to a race list screen showing a list of races held in the current turn, as shown in FIG. 14.

On the race list screen, the player can select a race in which the character being nurtured is made to enter by making a tap input to a race selection box 415. The race being selected can be identified on the basis of whether or not a selection mark 416 is provided on the race. Race condition information of the race being selected, such as season (spring, summer, autumn, and winter), weather (shine, cloudy, rain, and snow), course state (firm, good, yielding, heavy), the number of race entry characters, and race-held turn, is displayed in a race condition display region 417. When the race being selected is changed, the details displayed in the race condition display region 417 are also changed in accordance with the race being selected. In addition, each of the races has race entry conditions defined therein according to the number of fans earned by the character being nurtured. In the case of a race the race entry conditions of which are not satisfied by the character being nurtured, the race selection box 415 appears grayed out, prohibiting the character being nurtured from entering in the race.

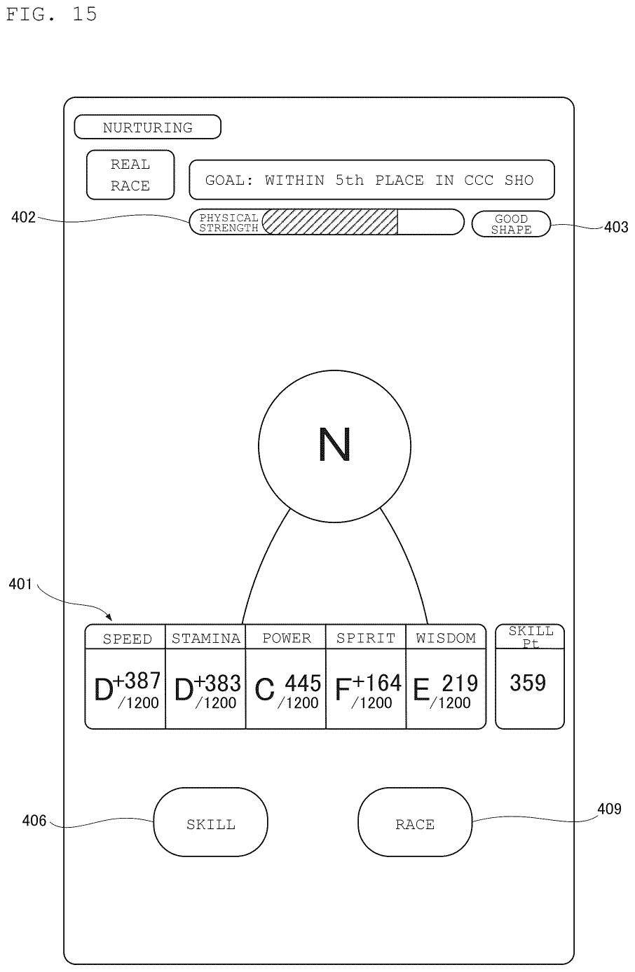

Furthermore, in this embodiment, a target race may be set as a nurturing goal. In a turn in which a target race is set, the nurturing home screen is displayed in a different manner, showing only the skill button 406 and the race button 409 as action selecting buttons, as shown in FIG. 15. That is, in a turn in which a target race is set, the player has no choice but to cause the character to enter in the race as a turn consumption action.

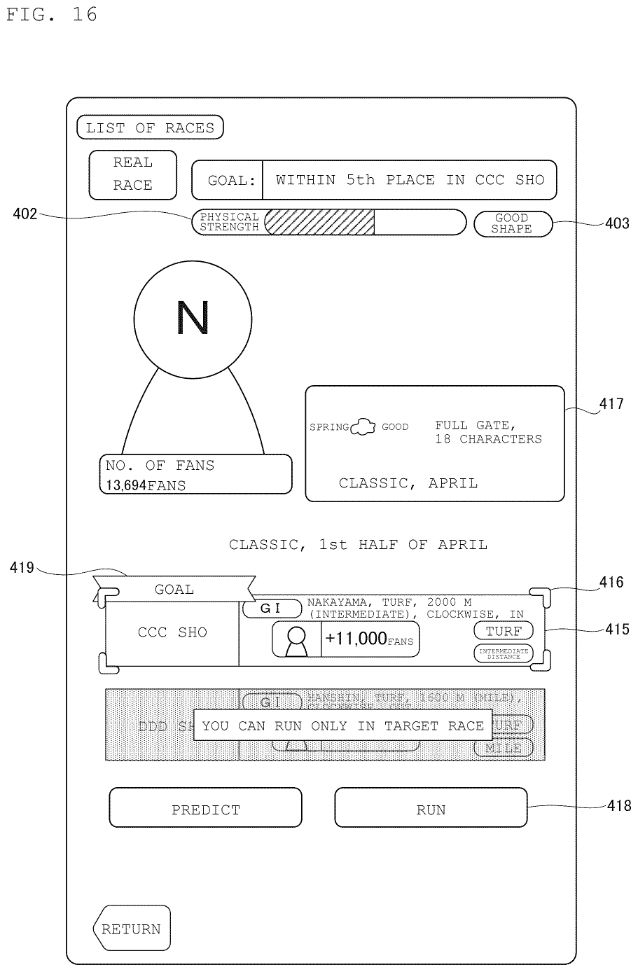

FIG. 16 is a drawing showing an example of the race list screen in a turn in which a target race is set. In the case where a target race is set as a nurturing goal, the game is controlled so that only the target race can be selected on the race list screen. In this embodiment, on the race list screen including a target race, the race selection box 415 of the target race is equipped with a target badge 416 that allows the race to be identified as a target race, and the race selection boxes 415 of races other than the target race appear grayed out, prohibiting the character from entering in the races.

When a tap input is made to a race entry button 418 while the selection box 415 of a race in which the character is to enter is selected on the race list screen, a race entry request is transmitted to the server 20. In the server 20 that has received the race entry request, competition simulation is executed for the entry race among the character being nurtured and NPCs (non-player characters), and a race result response including the result of competition simulation is transmitted to the player terminal 40. In the player terminal 40 that has received the race result response, a display process for allowing the player to watch how the race proceeds on the basis of the result of competition simulation is executed.

In this embodiment, in the case where the character being nurtured is made to enter in a race, performance parameters are adjusted according to the stage of the motivation in the turn in which the race entry is instructed, so that performance parameters are corrected to decrease in the case where the motivation is very bad shape or bad shape than in the case where the motivation is normal and so that performance parameters are corrected to increase in the case where the motivation is good shape or great shape than in the case where the motivation is normal.

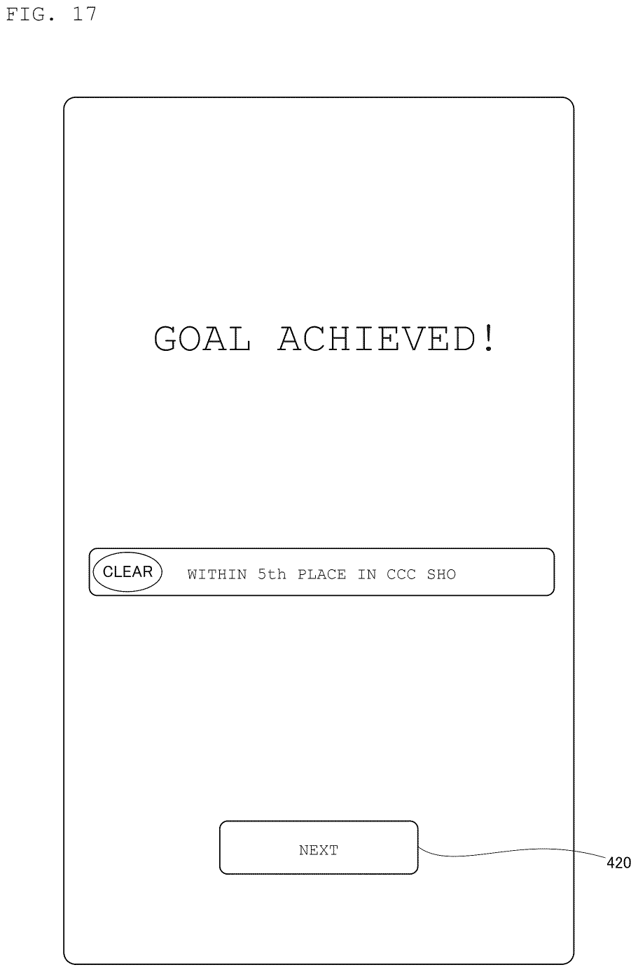

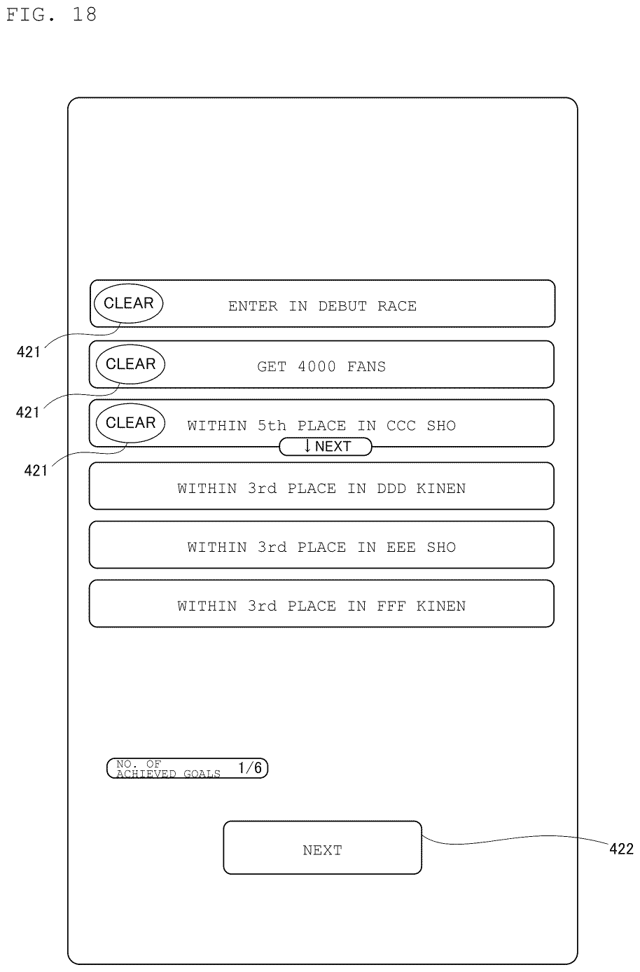

In character nurturing, it is determined in a turn in which a nurturing goal is set whether or not the nurturing goal has been achieved. In the case where the nurturing goal is achieved, a goal-achievement notification screen is displayed, as shown in FIG. 17. In the example shown in FIG. 17, the nurturing goal is to win a finish place within the fifth place in the “CCC Sho” serving as the target race. In the case where the character being nurtured succeeds in winning a finish place within the fifth place in the “CCC Sho”, the goal-achievement notification screen is displayed after the result of the target race is displayed. A proceeding button 420 is provided on the goal-achievement notification screen. When a tap input is made to the proceeding button 420, the display screen transitions to a goal list screen, as shown in FIG. 18.

On the goal list screen, a list of nurturing goals set for the character being nurtured is displayed in the order that the turns proceed. In the example shown in FIG. 18, six nurturing goals are set for the character being nurtured, and each of the nurturing goals up to the third nurturing goal “within the fifth place in the CCC Sho” is equipped with a clear mark 421, which indicates that the nurturing goal has been achieved. On the goal list screen, a proceeding button 422 is provided. When a tap input is made to the proceeding button 422, the current turn proceeds to the next turn, causing the display screen to return to the nurturing home screen.

In this embodiment, the nurturing goals are set in turns up to the 72nd turn, and the number of nurturing goals and details of the nurturing goals are set individually according to the character type. Also, when all nurturing goals are achieved for the character being nurtured, the player can proceed to the ending races in the 73rd and subsequent turns.

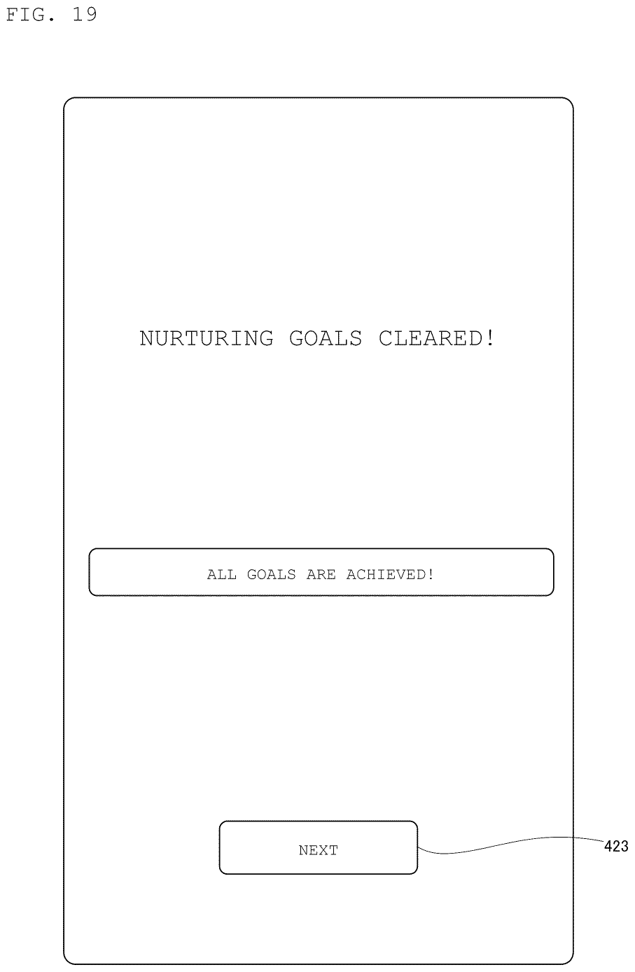

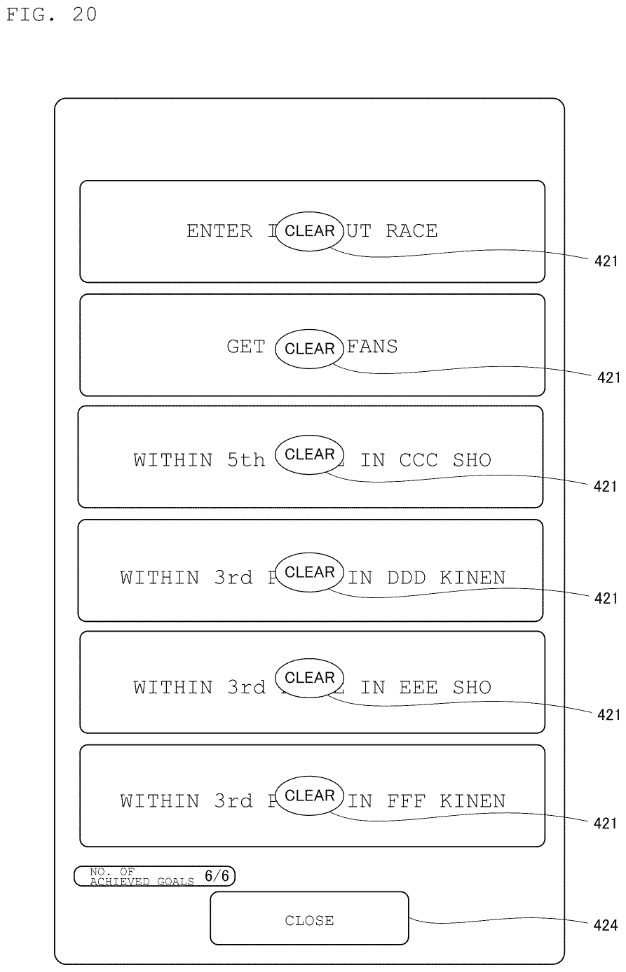

For example, when the final nurturing goal set for the character being nurtured is achieved, a nurturing-goal completion screen is displayed, as shown in FIG. 19. A proceeding button 423 is provided on the nurturing-goal completion screen. When a tap input is made to the proceeding button 423, the goal list screen is displayed, as shown in FIG. 20. On the goal list screen shown in FIG. 20, all the six nurturing goals set for the character being nurtured are equipped with clear marks 421, allowing the player to confirm that all nurturing goals have been achieved. Also, when a tap input is made to a close button 424 on the goal list screen, the player proceeds to the next turn, causing the display screen to return to the nurturing home screen.

In the case where all nurturing goals have been achieved in character nurturing, the 73rd and subsequent turns are processed such that the character is first made to enter in the elimination race, enter in the semi-final race after he/she has won the first place in the elimination race, and enter in the final race after he/she has won the first place in the semi-final race. When winning the first place in the final race, the character is regarded as the champion in the ending races, thus ending the nurturing. The player can also instruct the nurturing of the character before the character enters in each of the elimination race, semi-final race, final race in the respective turns. The 73rd and subsequent turns for the ending races are extra turns having no nurturing goals set therein. In the case where the player fails to win the first place in the elimination race or the semi-final race, he/she can retry those races by using the continue function, as long as there is a remaining continue token. In the case where there are no remaining continue tokens, the nurturing is ended. As described above, it is up to the player whether or not to select to use the continue function. Thus, in the case where the player selects not to use the continue function despite the fact that he/she can use it, he/she is regarded as losing the ending races at that time, thus ending the nurturing.

In addition, in the case where the player fails to achieve a nurturing goal set for the character being nurtured, the nurturing is ended at that time. In particular, in this embodiment, in the case where a nurturing goal is to win a finish place within a predetermined finish place in a target race, the player can retry the target race by using the continue function even if he/she fails to win a finish place within the predetermined finish place. In the case where nurturing goals are to earn a predetermined number of fans before a predetermined turn and enter in a target race, the player cannot use the continue function when he/she fails to achieve the nurturing goals, thus ending the nurturing in a turn subjected to a determination as to the nurturing goals.

Also, when a nurturing ending condition is satisfied in the nurturing proceeding process (Y in step S106), an ending confirmation process is executed (step S107). In the ending confirmation process, an ending confirmation screen that allows the player to confirm the statuses of the character serving as a nurturing object is displayed. A skill acquisition button and a nurturing ending button are provided on the ending confirmation screen. When a tap input is made to the skill acquisition button, a list of acquirable skills is displayed to allow the player to acquire skills within the range of possessed skill points. When a tap input is made to the nurturing ending button, a nurturing ending process is executed (step S108).

In the nurturing ending process, the statuses of the nurtured character are determined, and the nurtured character is registered. To determine the statuses of the nurtured character, evaluation scores are calculated, and factor information is decided. Registration of the nurtured character is completed by saving the statuses in the character list in the player data storage unit 71 so as to tie the statuses to the character individual ID. Evaluation scores are calculated on the basis of the performance parameters and acquired skills of the character, and factor information is decided by lottery.

Factor information is decided with reference to details (race entry history, etc.) in nurturing of the character and the statuses (performance parameters, acquired skills, etc.) at the time nurturing is ended. In addition, of the factor information, a blue factor and a red factor can always be earned, and the unique factor can be earned in the case where a talent-blooming level (level 1 to level 5), which indicates the rarity of the character serving as a nurturing object, is a predetermined level or higher (level 3 or higher). In addition, regarding the white factor of factor information, skill factors are decided with reference to the acquired skills, race factors are decided with reference to the races in which the character entered and won the first place during nurturing, and scenario factors are decided with reference to the nurturing scenario selected before the start of nurturing. Furthermore, when factor information to be tied to the character is to be decided, the factor level of the factor information decided as an earning object is decided by lottery. In this embodiment, three levels from level 1 to level 3 are prepared as the factor level, and any one of level 1 to level 3 is decided by lottery.

In addition, in the nurturing ending process, rewards for the result of nurturing are provided. In this embodiment, rewards are provided by adding them to the item list in the player data storage unit 71, and in-game currency and support points according to the number of fans earned during nurturing are decided as rewards. The larger the number of fans, the larger the amount of in-game currency and support points that can be earned.

Moreover, in the nurturing ending process, a nurturing ending request is transmitted to the server 20. In the server 20 that has received the nurturing ending request, the nurtured character is registered in the character list in the player management database 51, and rewards for the result of nurturing are added to the item list in the player management database 51.

Thus, in this embodiment, factor information is tied to the nurtured character as a result of the character being nurtured in the nurturing function. Also, the factor information tied to the nurtured character serves as factor information tied to an inheritance character when a new character is to be nurtured and is used to reinforce statuses of the character serving as a nurturing object. Because of this, in the case where the player fails to earn desired factor information after having nurtured a character in the nurturing function, he/she needs to nurture a character again.

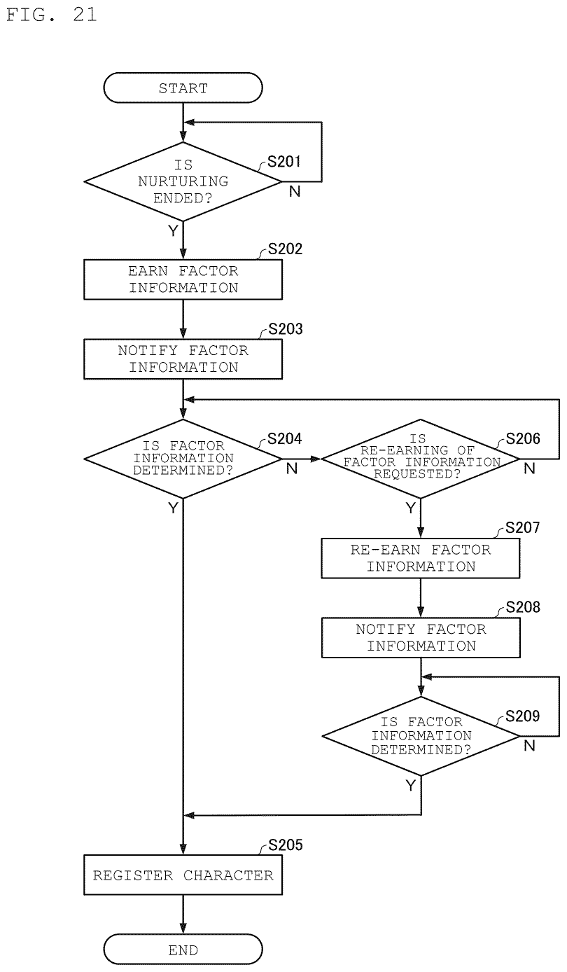

Given this situation, the present embodiment employs a mechanism in which after the player has been notified of factor information decided according to the result of character nurturing, he/she can request to re-earn factor information at his/her discretion. In the following, the flow of processing concerning decision of factor information will be described with reference to the flowchart shown in FIG. 21.

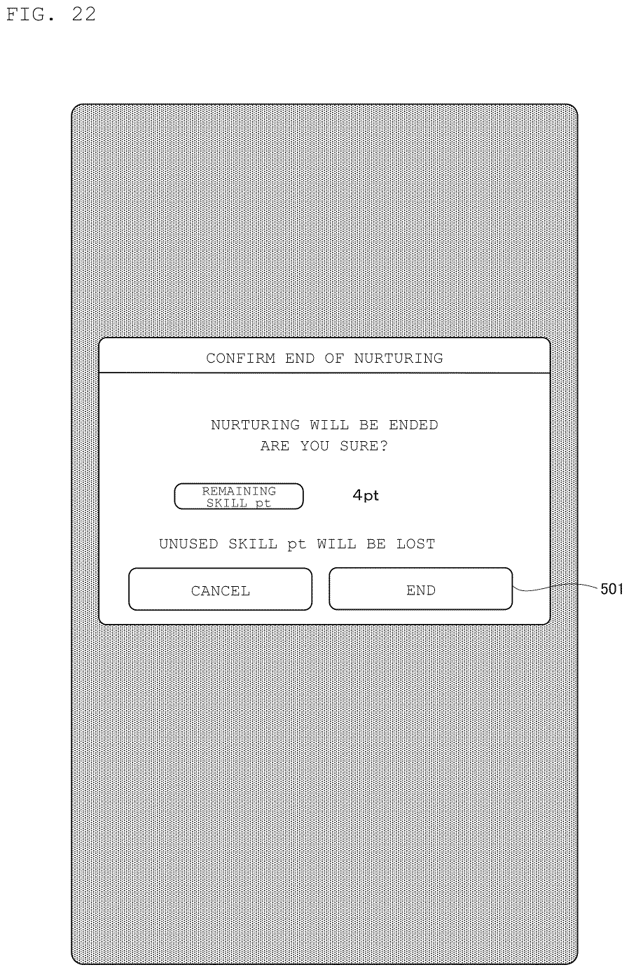

First, factor information is earned (step S202) on the basis of character nurturing being ended (Y in step S201). In this embodiment, a final confirmation dialog shown in FIG. 22 is displayed when character nurturing is ended, allowing the player to give final confirmation. When a tap input is made to an end button 501 while the final confirmation dialog is displayed, performance parameters, various kinds of aptitudes, possessed skills, etc. are determined with regard to the statuses of the character serving as a nurturing object, and a factor earning request is transmitted from the player terminal 40 to the server 20. In the server 20 that has received the factor earning request, a lottery for deciding factor information is drawn on the basis of the factor earning request, and the lottery result is transmitted to the player terminal 40.

In the lottery for deciding factor information, a first process for deciding an earning object and a second process for deciding a factor level are executed for each of the blue factor, red factor, unique factor, and white factor in the format corresponding to the factor type, thus deciding factor information.

First, regarding the blue factor, a lottery is drawn in the first process to select one of the five kinds of performance parameters: speed; stamina; power; spirit; and wisdom. In this embodiment, each of the performance parameters is selected at a chance of ⅕, i.e., the performance parameters have the same chance of being selected. When one kind of performance parameter serving as an earning object is decided, a lottery is drawn in the second process to decide any one of the factor levels from level 1 to level 3. The factor level concerning a blue factor is decided by lottery with reference to the value of the performance parameter at the time character nurturing is ended. The higher the value of the performance parameter serving as an earning object in the first process, the more likely a high factor level is to be selected in the second process. In addition, in order that level 3 is selected for the factor level concerning a blue factor, the value of the performance parameter needs to exceed a predetermined level (e.g., 600 or more).

Next, regarding the red factor, the first process is executed so that aptitudes with an aptitude rank A or higher at the time character nurturing is ended are extracted, and a lottery is then drawn to select any one kind of the extracted aptitudes as an earning object. For example, with the aptitudes of a character N as shown in FIG. 5, three kinds of aptitudes: the course aptitude “turf track”; the distance aptitude “long-distance”; and the running style aptitude “stalker” are extracted as aptitudes with an aptitude rank of A or higher, and any one of the three kinds is decided by lottery at an equal selection probability (⅓). In this embodiment, the aptitude rank of an aptitude of the character serving as a nurturing object may be increased by means of a factor inheritance event as a result of being affected by information concerning the red factor of an inheritance character. For this reason, when the character serving as a nurturing object has an increased number of aptitudes with an aptitude rank A or higher due to a factor inheritance event, the number of aptitudes to be decided by lottery in the first process also increases.

Note that, in the first process concerning the red factor, with reference to information concerning the red factors tied to the two inheritance characters selected before the start of nurturing the character serving as a nurturing object, the selection probability may be corrected to increase according to the kind of the red factor tied to each of the inheritance characters. For example, in the case where the red factors tied to the two inheritance characters relate to the course aptitude and the distance aptitude, selection probabilities concerning the course aptitude and the distance aptitude can be corrected to exceed the selection probability of the running style aptitude. In addition, in the case where both the red factors tied to the two inheritance characters relate to the distance aptitude, the selection probability concerning the distance aptitude can be corrected to exceed the selection probabilities of the course aptitude and the running style aptitude.

Also, when one kind of aptitude serving as an earning object is decided in the first process, a factor level is decided from level 1 to level 3 in the second process. The factor level concerning a red factor is decided by lottery with reference to the aptitude rank at the time character nurturing is ended, and the higher the aptitude rank of the aptitude decided as an earning object in the first process, the more likely a high factor level is to be selected in the second process. In this embodiment, eight stages of aptitude ranks, including S, A, B, C, D, E, F, and G are prepared for each of the aptitudes. In order to be extracted as red-factor earning-object candidates, aptitudes need to have an aptitude rank of A or higher (A or S). In the case where an aptitude selected as a red-factor earning object has an aptitude rank of S, a higher factor level is more likely to be selected for the aptitude than in the case where the aptitude has an aptitude rank of A.

Next, a determination is made as to the unique factor in the first process according to the rarity of the character. In this embodiment, information called a talent-blooming level is available as the rarity of the character serving as a nurturing object, wherein the talent-blooming level is set to one of level 1 to level 5. The talent-blooming level is treated such that level 1 corresponds to the lowest rarity and level 5 corresponds to the highest rarity. Each of the characters has, as an initial status, an acquired skill unique to the character (referred to as a unique skill), and the skill level of the unique skill increases when a predetermined condition is satisfied in the course where the character is nurtured in the nurturing function. The level of the unique skill affects the effect of the skill, and the higher the level of the unique skill, the more profound the effect when the skill is invoked. In the first process concerning the unique factor, it is determined that the unique factor can be earned in the case where the talent-blooming level of the character serving as a nurturing object is level 3 or higher (level 3 to level 5). That is, in the case where the talent-blooming level of the character serving as a nurturing object is level 2 or less (level 1 or level 2), it is determined that the unique factor cannot be earned in the first process concerning the unique factor. Note that, in the first process concerning the unique factor, the unique skill may be referenced, instead of the talent-blooming level, to determine whether or not the unique factor can be earned. In this embodiment, a character with a talent-blooming level of level 2 or lower and the same kind of character with a talent-blooming level of level 3 or higher have different unique skills. Thus, the talent-blooming level of the character can thus be determined substantially with reference to the unique skill.

Also, in the case where it is determined that the unique factor can be earned in the first process, the factor level is decided from level 1 to level 3 in the second process. The factor level concerning the unique factor is decided by lottery with reference to the skill level of the unique skill of the character serving as a nurturing object, and the higher the skill level, the more likely a high factor level is to be selected in the second process. Note that the factor level of the unique factor may be decided by lottery with reference to the talent-blooming level of the character serving as a nurturing object, and the higher the talent-blooming level, the more likely a high factor level may to be selected in the second process.

Next, a lottery is drawn to decide a white-factor earning object in the first process with reference to the possessed skills and the nurturing history of the character. In this embodiment, a skill factor, a race factor, and a scenario factor are available as the white factor, and earning-object candidates are set for each of the factors. First, regarding the skill factor, factor information corresponding to normal skills (skills other than the unique skill) acquired by the character at the time nurturing is ended is set as earning-object candidates. In addition, regarding the race factor, factor information corresponding to races in which the character entered during character nurturing, that have a race grade thereof set to G1, and in which the character resulted in winning the first place is set as earning-object candidates. Furthermore, regarding the scenario factor, factor information corresponding to the nurturing scenario selected by the player before the start of character nurturing is set as earning-object candidates. Also, whether or not to earn each of the earning-object candidates set for the skill factor, race factor, and scenario factor is decided by lottery, and the earning-object candidates that have been won are decided as white-factor earning objects. Note that, in this embodiment, the higher the nurturing rank of the nurtured character, the more advantageous the winning probability of a lottery for deciding whether or not to earn each of the earning-object candidates. An evaluation score is calculated on the basis of the statuses of a character the nurturing of which has been completed and is classified into a character nurturing rank according to rank determination criteria, wherein the higher the evaluation score, the higher the character nurturing rank. That is, when character nurturing is ended with a high nurturing rank, the number of white-factor earning objects tends to increase. In addition, in this embodiment, in the case where the white factors serving as earning-object candidates include a white factor tied to an inheritance character, the winning probability of a lottery for deciding the white factor becomes more advantageous. That is, regarding the white factor, the same factor information as that of the inheritance characters is more likely to be earned.

Also, when white factors serving as earning objects are decided in the first process, the factor level of each of the white factors serving as earning objects is decided from level 1 to level 3 in the second process. The factor level concerning a white factor is also decided by lottery with reference to the nurturing rank, and the higher the nurturing rank, the more likely a high factor level is to be selected in the second process.

Regarding skill factors of the white factor, as the rarity of a skill possessed by the character is higher, the winning probability of a lottery for deciding the skill factor is more advantageous in the first process, and a high factor level is more likely to be selected in the second process. For example, there are a lower skill (e.g., intermediate-distance straight with circle) and a higher skill (e.g., intermediate-distance straight with double circle) that cannot be simultaneously possessed by one character, and in the case where the character possesses a higher skill at the time nurturing is ended, factor information of the white factor corresponding to the skill (e.g., intermediate-distance straight with circle) is earned with higher priority than in the case where the character possesses a lower skill at the time nurturing is ended.

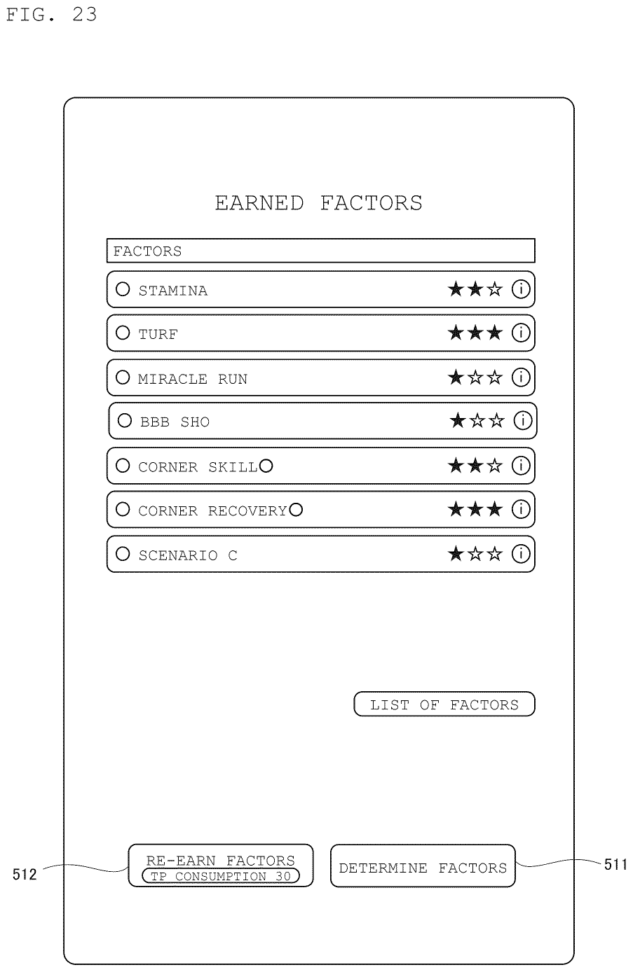

Also, when the result of the lottery for deciding factor information of the character serving as a nurturing object is acquired from the server 20 in the player terminal 40, an earned-factor notification screen shown in FIG. 23 is displayed, notifying the player of the factor information acquired from the server 20 as the factor information earned in this round of nurturing (step S203).

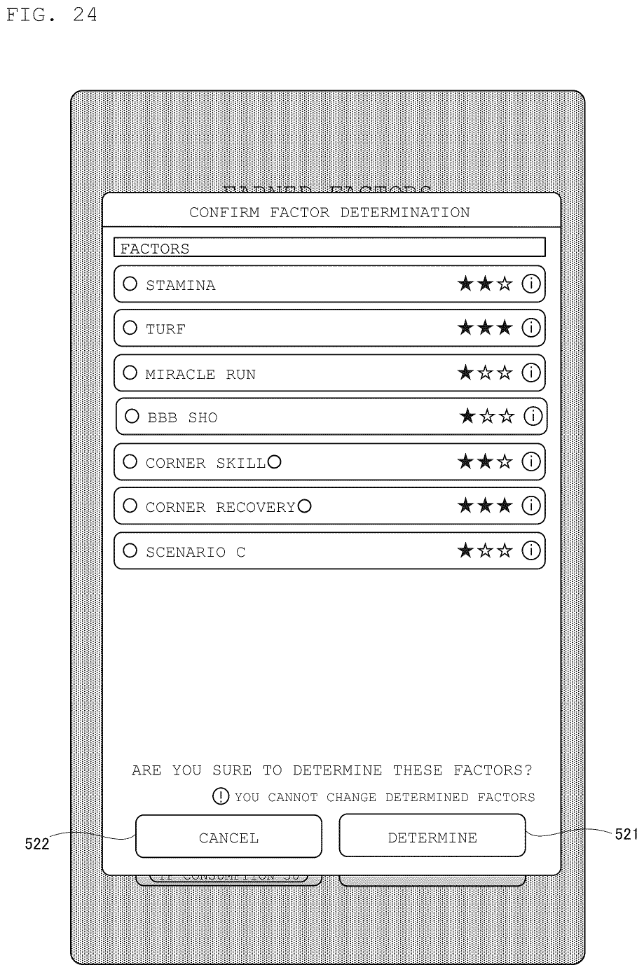

On the earned-factor notification screen, which is provided with a factor determination button 511 and a factor re-earning button 512, the factor information acquired from the server 20 is listed. When a tap input is made to the factor determination button 511 while the earned-factor notification screen is displayed, a factor-determination confirmation dialog shown in FIG. 24 is displayed. Also, when a tap input is made to a determination confirmation button 521 provided on the factor-determination confirmation dialog (Y in step S204), the factor information to be tied to the character nurtured this time around is determined and is then registered, as a nurtured character, in the character list in the player management database 51 and the character list in the player data storage unit 71 (step S205). Note that in the case where a tap input is made to a cancel button 522 while the factor-determination confirmation dialog is displayed, the factor-determination confirmation dialog is closed, causing the display screen to return to the earned-factor notification screen.

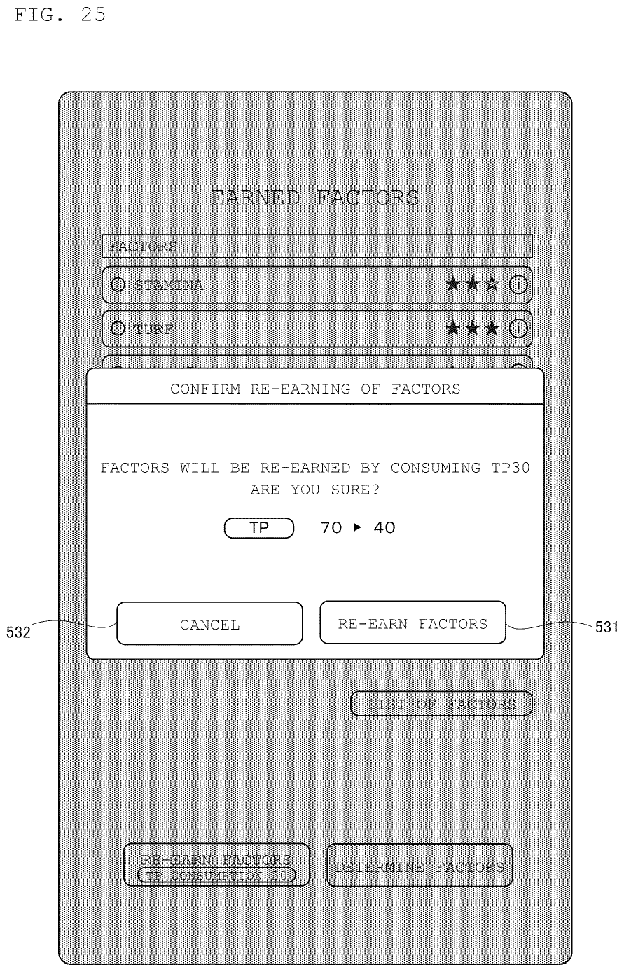

In addition, when a tap input is made to the factor re-earning button 512 while the earned-factor notification screen is displayed, a factor re-earning confirmation dialog shown in FIG. 25 is displayed. Also, when a tap input is made to a re-earning confirmation button 531 provided on the factor re-earning confirmation dialog (Y in step S206), a factor re-earning request for requesting to re-earn factor information is transmitted from the player terminal 40 to the server 20, thereby allowing the character to re-earn factor information (step S207). Regarding re-earning of factor information, the player is required to consume trainer points (TP) needed when a character is to be nurtured. In the case where the trainer points (TP) possessed by the player are insufficient, the player can re-earn factor information by replenishing trainer points by using a recovery item or the like. Furthermore, this embodiment is designed so that trainer points (TP) are recovered over time by a predetermined amount at a time. Thus, in the case where the earned-factor notification screen is displayed while the trainer points (TP) possessed by the player are insufficient to re-earn factor information, the player can resume the nurturing function after transitioning to another screen, such as resuming the nurturing function after calling another function of the application or resuming the nurturing function by starting the application after ending the application by means of task kill, thereby possibly allowing the character to re-earn factor information by possessing trainer points (TP) recovered over time. In this embodiment, the character can re-earn factor information by consuming the trainer points (TP) equivalent to the consumption needed to start character nurturing. In the server 20 that has received the factor re-earning request, a lottery for deciding factor information is re-drawn on the basis of the factor re-earning request, and the lottery result is transmitted to the player terminal 40. In particular, in this embodiment, in a factor-information deciding lottery to be drawn on the basis of the factor re-earning request, each of the blue factor, the red factor, the unique factor, and the white factor is subjected to the first process and the second process under the same conditions as those for the lottery for deciding factor information drawn on the basis of the factor earning request that has been made earlier, thereby deciding factors serving as earning objects and the factor levels thereof. Note that a cancel button 532 is provided in the factor re-earning confirmation dialog, and when a tap input is made to the cancel button 532, the display screen returns to the earned-factor notification screen.

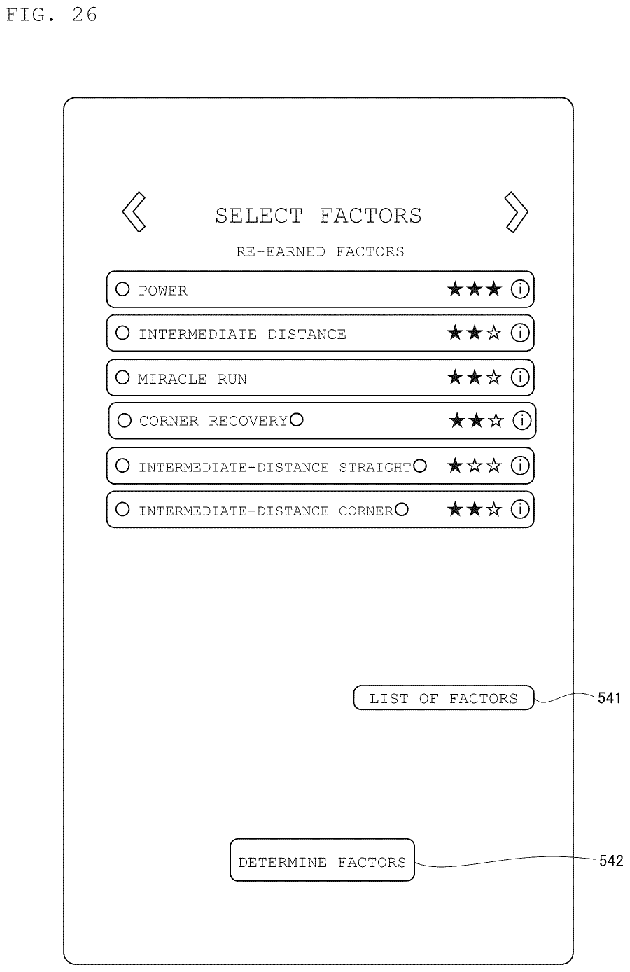

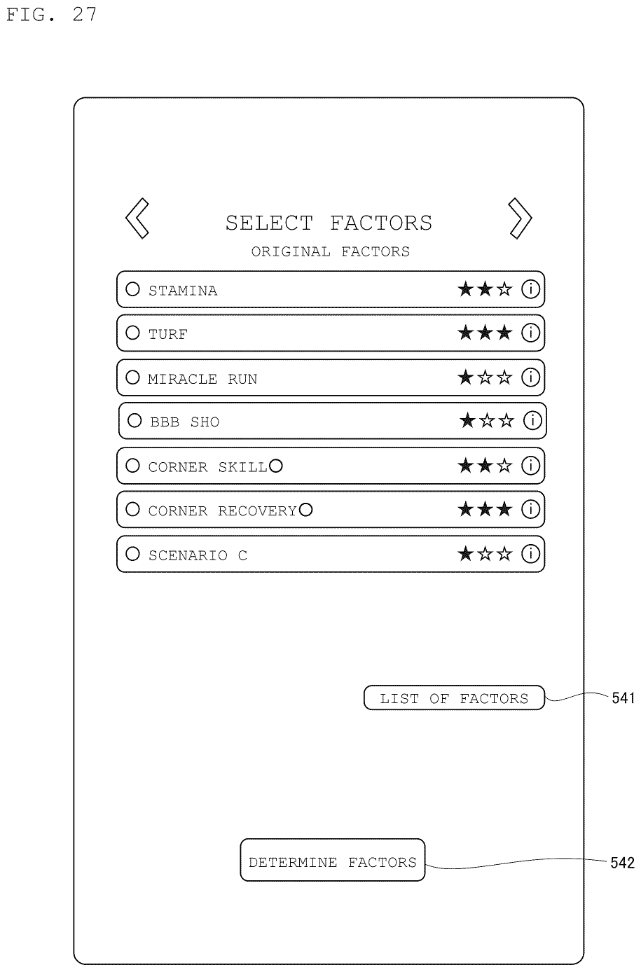

Also, when the lottery result of the factor information of the character serving as a nurturing object is acquired from the server 20 in the player terminal 40, an earning-factor selection screen shown in FIG. 26 and FIG. 27 is displayed, and the player is notified of the factor information acquired from the server 20 on the basis of the factor re-earning request in such a manner that the re-earned factor information can be compared with the factor information acquired earlier (step S208). Note that the factor information acquired from the server 20 on the basis of the factor re-earning request may be only the factor information decided on the basis of the factor re-earning request or may be both the original factor information decided on the basis of the factor earning request and the new factor information decided on the basis of the factor re-earning request.

On the earning-factor selection screen, factor information acquired earlier is displayed as “original factors”, as shown in FIG. 27, and factor information acquired later is displayed as “re-earned factors”, as shown in FIG. 26. Display can be switched between the “original factors” and the “re-earned factors” by making a swipe input either leftward or rightward on the earning-factor selection screen.

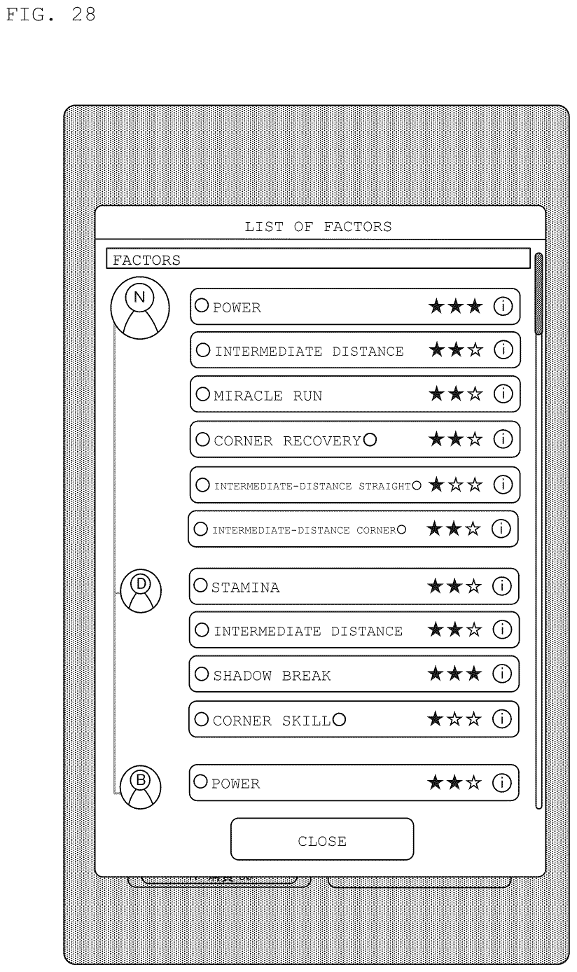

In addition, when a tap input is made to a factor list button 541 provided on the earning-factor selection screen, a factor list dialog is displayed, as shown in FIG. 28, and the factor information of the character serving as a nurturing object (e.g., character N) and two inheritance characters (e.g., character D and character B) are tree-displayed, thereby allowing the player to confirm in advance factor information that would be earned if the character serving as a nurturing object were registered as a nurtured character in the character list. Note that the factor information of the character serving as a nurturing object that is displayed in the factor list dialog is the factor information displayed on the earning-factor selection screen. That is, in the case where the factor list dialog is displayed while the “original factors” are displayed on the earning-factor selection screen, the “original factors” will be the factor information of the character serving as a nurturing object. On the other hand, in the case where the factor list dialog is displayed while the “re-earned factors” are displayed on the earning-factor selection screen, the “re-earned factors” will be the factor information of the character serving as a nurturing object.

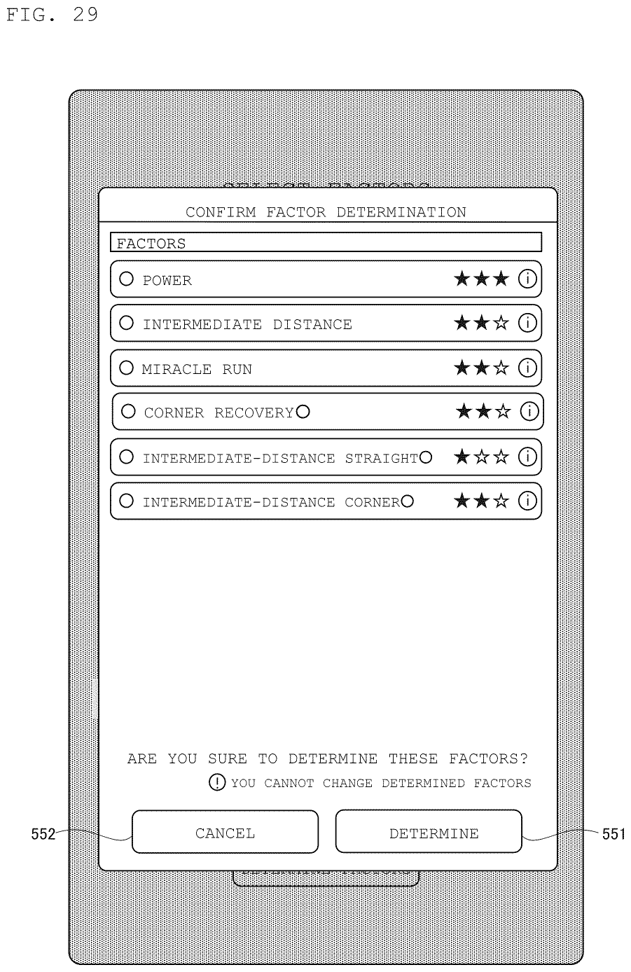

A factor determination button 542 is also provided on the earning-factor selection screen, and when a tap input is made to the factor determination button 542, the factor-determination confirmation dialog is displayed assuming that the player has selected the factor information being displayed on the earning-factor selection screen. For example, as shown in FIG. 26, when a tap input is made to the factor determination button 542 while “re-earned factors” are selected, the factor-determination confirmation dialog in which the factor information corresponding to the “re-earned factors” is displayed appears, as shown in FIG. 29. Also, when a tap input is made to a determination confirmation button 551 provided in the factor-determination confirmation dialog (Y in step S209), the factor information to be tied to the character nurtured this time round is determined, and is then registered as a nurtured character in the character list in the player management database 51 and the character list in the player data storage unit 71 (step S205). Note that in the case where a tap input is made to a cancel button 552 while the factor-determination confirmation dialog is displayed, the factor-determination confirmation dialog is closed, causing the display screen to return to the earning-factor selection screen.

In the aforementioned information processing system 10 according to this embodiment, factor information to be tied to the character serving as a nurturing object can be changed on the basis of the result that the character has been nurtured by means of the nurturing function. This can reduce the player's burden of repeatedly nurturing a character until he/she can obtain desired factor information.

In addition, in this embodiment, factor information to be tied to the character serving as a nurturing object is decided with reference to the statuses of the character at the time nurturing of the character is ended in the nurturing function. That is, in this embodiment, the player cannot know factor information to be tied to the character until character nurturing is ended in the nurturing function. For this reason, in the case where it takes increasing time to nurture one character due to increased content of the nurturing function, etc., there is risk that an enormous amount of time is required until the player can obtain desired factor information. In this embodiment, however, even in the case where the content of factor information presented at the time character nurturing is ended is not what is desired by the player, it is expected that the time taken until the player can obtain desired factor information is reduced because the player can re-earn factor information to be tied to the character nurtured this time round.

Also, in this embodiment, in the case where a character is nurtured in the nurturing function, a factor inheritance event that affects statuses of the character serving as a nurturing object occurs according to the factor information tied to a character that was nurtured in the past. That is, this embodiment is designed so that it is easier to nurture a powerful character because a nurtured character to which excellent factor information is tied can be selected as an inheritance character. In addition, in this embodiment, because each player has a quota for nurtured characters that can be possessed, the player wishes to possess nurtured characters to which factor information as excellent as possible is tied. For this reason, if factor information to be tied to the character nurtured this time round can be re-earned as designed in this embodiment, it is possible to reduce the player's burden of carefully selecting, on the basis of the factor information tied to the character, whether or not to possess the nurtured character.

Furthermore, in this embodiment, a lottery for deciding factor information to be tied to the character is redrawn under the same conditions as those for the factor information that has been notified to the player, and this readily works as a trigger for the player to decide to re-earn factor information. Note that this embodiment is designed so that a lottery is repeatedly drawn to decide factor information for one character. In the case where factor information is to be re-earned, however, the player may be allowed to internally produce a duplicated character by tracing the nurturing history of the nurtured character (original character), decide factor information for the duplicated character, and select which of the original character and the duplicated character to register. Note that conditions for a lottery concerning re-earning of factor information (second lottery) do not always need to be the same as those for the first lottery. The second lottery concerning re-earning of factor information may be probabilistically more advantageous or disadvantageous in re-earning factor information than the first lottery. Furthermore, in the case where a lottery concerning re-earning of factor information is to be drawn, a lottery concerning deciding factor information may be drawn with reference to internally corrected statuses of the character. For example, in a lottery for deciding a white-factor earning object, the nurturing rank of the character may be internally corrected to S in the lottery concerning re-earning even though the character actually has a nurturing rank of A, thereby making it possible to draw the lottery for deciding a white-factor earning object under more advantageous conditions than those with the original nurturing rank.

In addition, in this embodiment, in the case where factor information is re-earned, the factor information that has been acquired earlier and the factor information that has been acquired later are displayed on the earning-factor selection screen so that the two items of factor information can be compared, thereby allowing the player to select which of the two items of factor information should be tied to the character. That is, because the player can determine factor information to be tied to the character at his/her discretion by comparing the factor information concerning the “original factors” and factor information concerning the “re-earned factors”, the convenience to the player can be enhanced. In this embodiment, the player is allowed to select factor information to be tied to the character by comparatively considering the “re-earned factors” while retaining the “original factors”. However, in the case where re-earning of factor information is requested, the factor information corresponding to the “original factors” may be discarded, and the factor information corresponding to the “re-earned factors” may be registered so as to be tied to the character.

Moreover, this embodiment has been described by way of an example where the display on the earning-factor selection screen is switched between the factor information concerning the “original factors” and the factor information concerning the “re-earned factors” via a swipe input. However, it is also acceptable to display the factor information concerning the “original factors” and the factor information concerning the “re-earned factors” on the same screen, so that the player can compare and confirm both factor information without switching the display. In addition, on the earning-factor selection screen, one of the factor information concerning the “original factors” and the factor information concerning the “re-earned factors” may be displayed so as to show the differences from the other.

Furthermore, this embodiment has been described by way of an example where factor information is decided by lottery. However, some or all items of factor information may be decided and tied to the character without drawing a lottery. For example, all of the skills possessed by the character may be earned as factor information. In addition, although factor information includes a factor type and a factor level, the factor level does not need to be provided.

Moreover, this embodiment has been described by way of an example where factor information can be re-earned only once. However, the character may be able to re-earn factor information multiple times on condition that trainer points (TP) are consumed as a remuneration. In the case where factor information can be re-earned repeatedly, the present embodiment may be designed so that the consumption of trainer points (TP) needed to re-earn factor information is increased each time factor information is re-earned.

Furthermore, the remuneration for re-earning factor information may be classified into stages, so that when factor information is to be re-earned, the character is favored at the player's discretion according to the stage of the consumed remuneration. For example, the present embodiment may be designed so that in the case where factor information is to be re-earned, a larger number of white factors can be earned as the consumption of trainer points (TP) becomes higher.

In addition, in this embodiment, a predetermined amount of trainer points (TP) need to be consumed on each round of character nurturing in the nurturing function, and this consumption may vary only within a period of time due to an event, a campaign, or the like. In contrast, trainer points (TP) consumed when factor information is to be re-earned are equivalent to a predetermined amount of trainer points (TP) needed for one round of normal nurturing. That is, in this embodiment, factor information can be re-earned by consuming a certain amount of trainer points (TP), without linking to the consumption of trainer points (TP) when nurturing is started. However, the consumption of trainer points (TP) needed to re-earn factor information may vary in conjunction with the consumption of trainer points (TP) when nurturing is started. Furthermore, in this embodiment, there is a remuneration needed to pay for re-earning of factor information. However, it is also acceptable that factor information can be re-earned without a remuneration.

In addition, this embodiment has been described by way of an example where factor information can be re-earned before the nurtured character is registered in the character list to allow the player to change factor information to be tied to the character. However, it is also acceptable that the player can change the factor information tied to the nurtured character at any timing as determined by the player after the nurtured character has been registered in the character list. It should be noted, however, that taking into account a case where a nurtured character used as an inheritance character is rented from another player registered as a friend, as designed in this embodiment, a nurtured character allowed by one player to be rented by another player as an inheritance character may be restricted such that the factor information of the inheritance character cannot be changed. In addition, as an aspect for changing factor information, it is acceptable that the factor level of any factor information of a nurtured character registered in the character list can be enhanced by consuming a predetermined item. As an aspect for changing factor information, in the case where the factor level can be enhanced by using an item, it is possible to allow the player to decide whether or not to consume an item that can enhance the factor level at a stage of accepting an input for determining factor information of the character serving as a nurturing object. Furthermore, as an aspect for changing factor information, in the case where the factor level can be enhanced by using an item, it is possible to allow the player to decide whether or not to consume an item that can enhance the factor level after the character serving as a nurturing object is registered in the character list. In addition, as an aspect for changing factor information, if the present embodiment is designed so that a factor level is enhanced by consuming an item, the player does not need to have a chance to re-earn factor information of a character the nurturing of which has been completed. Furthermore, as an aspect for changing factor information, if the present embodiment is designed so that a factor level is enhanced by consuming an item, factor information the factor level of which is to be enhanced by consuming an item may be decided randomly.

Moreover, changing of factor information includes the player sorting out factor information. The present embodiment may be designed so that the number of items of factor information to be earned is defined by lottery or according to the nurturing rank, and the player edits factor information to be tied to the character, within the range of the defined number of items of factor information to be earned, from the factor information earning candidates based on the character statuses and character nurturing history and registers the character in the character list by tying the factor information based on the result of editing to the character.

In addition, changing of factor information includes changing only some items of the original factor information. For example, arbitrary factor information based on the result of the first lottery for factor information may be replaced with factor information based on the result of the second lottery for factor information to produce factor information to be tied to the character. In addition, the present embodiment may also be designed so that the player can change only factors that can be definitely earned, such as the blue factor and the red factor, through re-earning of factor information and so that the player can decide and replace only a blue factor and a red factor in a lottery concerning re-earning of factor information. Moreover, in the case where the lottery results of the first and second lotteries concerning decision of factor information indicate that the same factor is decided as an earning object, the factor may be corrected to have a higher factor level than in the first lottery result.

In addition, the present embodiment may also be designed so that individual factor information can be selected and eliminated on the earned-factor notification screen, and, as a result of some items of factor information being eliminated, the factor levels of the remaining items of factor information can be increased. In this case, the present embodiment may be designed so that, by eliminating one item of factor information, the factor levels of the other items of factor information can be increased by one level, regardless of the factor level of the eliminated item of factor information. Moreover, the present embodiment may be designed so that the amount of increase in the level corresponding to the factor level of eliminated factor information (e.g., three levels in the case where factor information with a factor level of level 3 is eliminated) can be distributed to the other items of factor information.

Furthermore, although this embodiment has been described by way of an example where a lottery concerning re-earning of factor information is drawn on the basis of an input made by the player, two lotteries (first lottery and second lottery) may be drawn in advance under the same conditions at the time character nurturing is ended, and the result of only the first lottery may be presented, so that the second lottery result is presented on the basis of an input made by the player. In the case where two lotteries are drawn in advance, which of the lottery results should be presented can be determined according to pre-defined priority. For example, the lottery results to be presented first can be decided according to an arbitrary reference, such as the number of items of earned factor information or the factor level concerning particular factor information.

In addition, this embodiment has been described by way of an example where when white-factor earning objects are to be decided, earning-object candidates are extracted from the possessed skills, race entry history, nurturing scenario, etc. of the character, and it is decided whether or not to earn each of the extracted earning-object candidates. However, when a lottery for deciding a white-factor earning object is drawn, a lottery for deciding the number of earning objects may be drawn first at a probability according to the nurturing rank of the character, and white-factor earning objects may then be decided from the white-factor earning-object candidates within the range of the upper limit number of earning objects determined in the lottery.

Furthermore, the present embodiment may be designed so that when factor information is to be re-earned, a lock can be set with regard to original factor information, so that factor information having a lock set therefor is transferred to the re-earned factor information. In the case where a lock can be set with regard to original factor information, it may be allowed to set a lock only for one kind of the blue factor, red factor, and unique factor, set a lock for all of the blue factor, red factor, and unique factor, or re-decide only the white factor. It is also allowed to set a lock for white factors within a limited number of white factors.

Although this embodiment has been described by way of an example of a game where two of the nurtured characters can be set as inheritance characters when a character is to be nurtured, the number of inheritance characters to be selected may be at least one, and this embodiment thus may also be realized such that three or more inheritance characters can be set. Furthermore, this embodiment may be configured such that each of the functions of the information processing system 10 is provided in another game. For example, this embodiment can be applied to a sport game, such as a baseball game and a soccer game, where a player can nurture characters to participate in a competition, hold a competition using the nurtured characters, reinforce statuses of a character to be newly nurtured by using nurtured characters, etc. Furthermore, this embodiment may be applied to games of other genres, such as a card battle game, a battle game, an action game, a battle royal game, and a role-playing game, where a player can nurture characters, hold a competition using the nurtured characters, reinforce statuses of a character to be newly nurtured by using nurtured characters, etc.

1. A program for a game in which a game medium having specific information tied thereto is registered in a database so as to be tied to a player, the program causing a computer to function as:
a specific information decision unit for deciding specific information to be tied to the game medium used in a predetermined game on the basis of a result of the predetermined game being executed; and
a specific information change unit for making it possible to change the specific information to be tied to the game medium after the player has been notified of the specific information.

2. The program according to claim 1,
wherein the predetermined game is a game for nurturing the game medium, and
the specific information decision unit decides the specific information to be tied to the game medium with reference to a status, at a predetermined point of time, of the game medium serving as a nurturing object in the predetermined game.

3. The program according to claim 1,
wherein the predetermined game is a game for nurturing the game medium, and
the program causes the computer to function as a specific information application unit that, in the case where the game medium is nurtured in the predetermined game, affects a status of the game medium serving as a nurturing object according to specific information tied to a game medium nurtured in the past.

4. The program according to claim 1,
wherein the specific information change unit accepts a specific input for requesting to re-decide specific information after the player has been notified of the specific information, and
the specific information decision unit, on the basis of the specific input being made, re-decides the specific information to be tied to the game medium under the same condition as that for the specific information notified to the player.

5. The program according to claim 1,
wherein the specific information change unit displays specific information acquired earlier for the game medium and specific information acquired later for the game medium so that the two items of specific information can be compared and allows the player to select which of the two items of specific information is to be tied to the game medium.

6. An information processing system for a game in which a game medium having specific information tied thereto is registered in a database so as to be tied to a player, the information processing system comprising:
a specific information decision unit for deciding specific information to be tied to the game medium used in a predetermined game on the basis of a result of the predetermined game being executed; and
a specific information change unit for making it possible to change the specific information to be tied to the game medium after the player has been notified of the specific information.

7. An information processing method for a game in which a game medium having specific information tied thereto is registered in a database so as to be tied to a player, the method comprising:
a specific information decision step for deciding specific information to be tied to the game medium used in a predetermined game on the basis of a result of the predetermined game being executed; and
a specific information change step for making it possible to change the specific information to be tied to the game medium after the player has been notified of the specific information.
